(19) United States
(12) Patent Application Publication
(10) Pub. No.: US 2018/0370025 A1
(43) Pub. Date: Dec. 27, 2018

(54) CONNECTION SYSTEM FOR A MODULAR ROBOT

(71) Applicant: REACH ROBOTICS LIMITED, Bristol (GB)

(72) Inventors: Arnaud DIDEY, Bristol (GB); Christopher James BECK, Bristol (GB); John Lee REES, Bristol (GB)

(21) Appl. No.: 15/917,318

(22) Filed: Mar. 9, 2018

Related U.S. Application Data
(63) Continuation of application No. PCT/GB2016/052739, filed on Sep. 6, 2016.
(60) Provisional application No. 62/216,288, filed on Sep. 9, 2015.

(51) Int. Cl. B25J 9/08; A63H 30/04; A63H 11/20; A63H 11/10; B25J 9/10

(52) U.S. Cl. CPC B25J 9/08; A63H 30/04; A63H 2011/16; A63H 11/10; B25J 9/102; A63H 11/20

(57) ABSTRACT

There is provided a gaming robot comprising at least one movable joint actuated by a prime mover. The gaming robot comprises a first module comprising first electronic circuitry and a first coupling. The first coupling is connectable to a second coupling on a second module comprising second electronic circuitry to create a mechanical interface between the first module and the second module and an electrical interface between the first module and the second module. The first electronic circuitry is configured to: in response to a connection of the second module to the first module, access via the electrical interface data stored within the second electronic circuitry, said data identifying the second module; and transmit the data to an identification system configured to detect the presence and identification of modules attached to the gaming robot.

### CROSS-REFERENCE TO RELATED APPLICATIONS

This application is a continuation under 35 U.S.C. § 120 of International Application No. PCT/GB2016/052739, filed Sep. 6, 2016, which claims the benefit of U.S. Provisional Application No. 62/216,288, filed Sep. 9, 2015. Each of the above-referenced patent applications is incorporated by reference in its entirety.

### BACKGROUND OF THE INVENTION

### Field of the Invention

The present invention relates to a connection system for connecting modules of a modular robot, and to a connector for connecting a module to a modular robot.

### Description of the Related Technology

The consumer robotic market is expanding rapidly and a variety of robots are now available to consumers. Consumer robots tend to fit within two distinct categories. A first category of legged robot may be referred to as “toy” robots. Toy robots are typically available through mainstream retailers and are sold fully-assembled and ready to use. They have the appearance of a finished product and are aesthetically pleasing in the sense that the function of the robot has only a limited impact on the form of the robot. This is essentially because toy robots have only limited functionality, with relatively little freedom of movement (that is, as compared to other consumer robots), to limit the purchase cost. Toy robots are also typically not designed to be serviceable by the user and are therefore considered disposable items.

A second category of consumer robots may be referred to as “hobbyist” robots. Such robots are usually only available through specialist retailers and tend to have more advanced functionality than toy robots, due to the fact that cost and complexity is less of an issue for the market these robots address. Hobbyist robots often come in the form of a kit of parts for self-assembly by the user. They have increased freedom of movement compared with toy robots and may be serviced by the user, if required, to extend the product life. However; such hobbyist robots generally do not have the pleasing finished appearance of toy robots. Instead, they tend to be somewhat industrial in appearance in the sense that the form of the robot is largely dictated by its function.

Both toy robots and hobbyist robots rely on a combination of prime movers (typically electric motors, geared or direct-drive) and/or mechanisms to achieve the desired robotic motion. Each prime mover adds cost, complexity and reduces the overall reliability of the robot. As a result, toy robots tend to feature fewer prime-movers than hobbyist robots but consequently have far less freedom of movement than hobbyist robots.

For example a robotic leg having three joints may be actuated using three separate prime movers, to provide the leg with three degrees of freedom and allow the robot to walk with a fluid motion. In such a leg, two separately actuated joints may be coupled together to provide two degrees of freedom, similar to that provided by a human hip joint. To reduce cost and complexity, one or more of the joints may be coupled, using for example linkages or any other suitable mechanism, so that the number of prime movers can be reduced whilst retaining some (albeit restricted) motion in all joints. The robotic leg may be further simplified by fixing some of the joints, to reduce to a minimum the number of prime movers. This scenario is similar to a human leg where the knee and ankle are fixed in a plaster cast. It is still possible for the owner of the cast leg to move, but it would not be possible for them to run, jump or kneel down. Such limited mobility (or limited freedom of movement) is typical of toy robots.

The present disclosure relates to a robot which seeks to address the shortcomings of current hobbyist and toy robots. In particular, the present disclosure relates to a robot which can offer the versatility, freedom of movement and serviceability of a hobbyist robot, and which can also be inexpensive and aesthetically pleasing.

### SUMMARY

According to a first aspect of the present invention, there is provided a gaming robot comprising at least one movable joint actuated by a prime mover. The gaming robot comprises a first module comprising first electronic circuitry and a first coupling. The first coupling is connectable to a second coupling on a second module comprising second electronic circuitry to create a mechanical interface between the first module and the second module and an electrical interface between the first module and the second module. The first electronic circuitry is configured to: in response to a connection of the second module to the first module, access via the electrical interface data stored within the second electronic circuitry, said data identifying the second module; and transmit the data to an identification system configured to detect the presence and identification of modules attached to the gaming robot.

Thus certain examples described herein relate to a relatively new type of consumer robot called a gaming robot. These are used in conjunction with video games to merge physical and virtual worlds. This may be achieved with the help of augmented reality. This gaming robot may thus be used to represent a physical presence of a virtual game that is played on the computing device. Hence, the gaming robot combines physical and virtual gaming action. The gaming robot may be controlled in the physical world to complete game missions or battles that are represented in the virtual world. By attaching a secondary module, a user can modify the behaviour of the gaming robot in both physical and virtual worlds, i.e. in a closed loop manner. In this way physical modifications to the robot, e.g. attaching a part that has negligible physical impact on the robot, may result in a virtual modification to the attributes or characteristics of the gaming robot, which manifest in modified physical behaviour, such as modified movement and/or sequences of prime mover activations.

In use, the gaming robot may comprise a number of primary and secondary modules. Primary modules may comprise at least one of: the aforementioned main module, one or more locomotion modules, a body module and a battery module. Each of the primary modules may be couple-able to another primary module and/or one or more secondary modules. In one example, the gaming robot may have secondary modules comprising removable shields that attach to the legs of the robot and/or weapons that attach to a body of the robot. A secondary module may be associated with certain attributes, which may be indicated by data stored within electronic circuitry of the shield. For example, a shield may be deemed “heavy” or “light” in some example implementations, and whether or not such a shield is heavy or light may be identified using the data stored within electronic circuitry of the shield, e.g. a unique identifier or string sequence stored within a microcontroller memory. However; both “heavy” and “light” shields may have a comparable physical mass (or masses that have a small physical effect on the motion of the leg module). The computing device receives the data from the shield and determines whether it is “heavy” or “light”. In one case the data comprises an identifier indicating a type of secondary module. The computing device then modifies or alters the commands sent to the main processing module of the gaming robot, e.g. as compared to a base case where no shields are attached, such that the leg motion slows or is otherwise modulated in proportion to a virtual mass of the shield. For example, a “heavy” shield may double the virtual mass of the gaming robot and the robot may thus be sent commands that move it with half the acceleration of the base case where the gaming robot has no attached shields.

The modules of the gaming robot may be connectable by connectors which require no tools or expertise to use, and which thereby permit quick and easy connection, disconnection, replacement and interchanging of robot modules by a non-expert user. Such connectors may additionally be cost effective to manufacture, to maintain the overall cost of the gaming robot at a relatively low level. In some examples the connectors may be configured to mechanically constrain one or more degrees of freedom of a joint with which the connector is associated. For example, a connector associated with a pivoting joint may be configured to react twisting forces generated during operation of the pivoting joint. Such a constraining function can enhance the preciseness and controllability of the robot movement, and thereby improve user experience. The gaming robot may also include a connection system which is configured to verify the authenticity of a newly-connected module, so that the use of counterfeit modules can be prevented. Such a connection system may also advantageously be configured to prevent the connection of incorrect parts to the robot, and thereby can safe guard the robot from damage which may be caused to it by adding incorrect parts.

Optional features of gaming robots according to the first aspect are set out in appended dependent claims 2 to 14.

According to a second aspect of the present invention, there is provided a module for connection to a gaming robot comprising at least one movable joint actuated by a prime mover. The module comprises electronic circuitry storing data identifying the module; and a first coupling connectable to a corresponding second coupling of the gaming robot to create a mechanical interface between the module and the gaming robot and an electrical interface between the module and the gaming robot, for enabling the gaming robot to access the stored data.

The module may be for connection to a gaming robot according to the first aspect. Further optional features of modules according to the second aspect are set out in appended dependent claims 16 to 21.

According to a third aspect of the present invention, there is provided an identification system for detecting the presence and identification of modules attached to a gaming robot comprising at least one movable joint actuated by a prime mover. The identification system is configured to receive, from the gaming robot, data identifying a module connected to the gaming robot; and determine, based on the received data, whether the module is authentic.

The gaming robot may be a gaming robot according to the first aspect. The module may be a module according to the second aspect. Further optional features of identification systems according to the third aspect are set out in appended dependent claims 23 to 25.

According to a fourth aspect of the present invention, there is provided a remote computing device for controlling a gaming robot according to the first aspect. Further optional features of remote computing devices according to the fourth aspect are set out in appended dependent claims 27 to 32.

According to a fifth aspect of the present invention, there is provided a gaming robot system comprising a gaming robot according to the first aspect; a module for connection to the gaming robot according to the second aspect; and an identification system according to the third aspect. Further optional features of gaming robot systems according to the fifth aspect are set out in appended dependent claim 34.

According to a sixth aspect of the present invention, there is provided a method of connecting a module to a gaming robot comprising at least one movable joint actuated by a prime mover. The method comprises: providing a gaming robot comprising at least one movable joint actuated by a prime mover, the gaming robot comprising first electronic circuitry and a first coupling; providing a module to be connected to the gaming robot, the module comprising second electronic circuitry and a second coupling; engaging the second coupling with the first coupling to create an electrical interface between the module and the gaming robot and a mechanical interface between the module and the gaming robot; the first electronic circuitry accessing, via the electrical interface, data identifying the module stored within the second electronic circuitry; the first electronic circuitry transmitting the data to a an identification system configured to detect the presence and identification of modules attached to the gaming robot; and the identification system determining whether the module is authentic based on the received data.

The gaming robot may be a gaming robot according to the first aspect. The module may be a module according to the second aspect. The identification system may be an identification system according to the third aspect. Further optional features of methods according to the sixth aspect are set out in appended dependent claims 36 and 37.

According to a seventh aspect of the present invention, there is provided a connection system for a gaming robot controllable by a remote computing device. The gaming robot comprises a plurality of leg modules, each leg module comprising a plurality of prime movers to rotate portions of the leg module about a respective plurality of axes, a main module comprising a main processing module to control said plurality of leg modules; and a least one disconnectable module. The connection system comprises: a first electronic circuitry and a first coupling, the first electronic circuitry and the first coupling being comprised in a primary part of the gaming robot which comprises at least the main module; a second electronic circuitry and a second coupling configured to connect to the first coupling, the second electronic circuitry and the second coupling being comprised in the at least one disconnectable module; and a third electronic circuitry, the third electronic circuitry being comprised in the remote computing device and being communicatively coupled to the first electronic circuitry. At least one of the first electronic circuitry and the third electronic circuitry comprises an identification system configured to detect the presence and identification of modules attached to the gaming robot. The first coupling and the second coupling are configured to create an electrical interface and a mechanical interface between the primary part and the module when the first coupling is connected to the second coupling. The second electronic circuitry stores a unique identifier identifying the at least one disconnectable module. The first electronic circuitry is configured to read the unique identifier in response to the second coupling becoming connected to the first coupling and transmit the unique identifier to the identification system. The identification system is configured to determine whether the at least one disconnectable module is authentic based on the unique identifier.

The gaming robot may be a gaming robot according to the first aspect. The at least one disconnectable module may be a module according to the second aspect. The identification system may be an identification system according to the third aspect. The remote computing device may be a remote computing device according to the fourth aspect.

According to an eighth aspect of the present invention, there is provided a coupling pair for connecting two modules of a modular gaming robot. The coupling pair comprises a first coupling having a first set of electrical contacts and a first connection surface shaped to create a first set of formations; and a second coupling having a second set of electrical contacts for cooperating with the first set of electrical contacts to create an electrical interface when the two modules are connected, and a second connection surface shaped to create a second set of formations. At least one of the two modules forms part of a pivoting joint of the modular robot. The first set of formations and the second set of formations are configured such that movement of the first coupling into engagement with the second coupling along a connection axis substantially normal to the first connection surface creates a mechanical interface between the first coupling and the second coupling which resists further relative movement of the first coupling and the second coupling along the connection axis and which resists rotational movement of the first coupling relative to the second coupling around an axis parallel to the pivotal axis of the pivoting joint.

The gaming robot may be a gaming robot according to the first aspect. Either or both of the two modules may be a module according to the second aspect. Further optional features of coupling pairs according to the eighth aspect are set out in appended dependent claims 40 to 49.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows an example gaming robot;

FIG. 2A shows a main module;

FIG. 2B shows a leg module; and

FIG. 2C shows a body module of the example gaming robot of FIG. 1;

FIGS. 3A-3G show an example thigh of the example leg module of FIG. 2B;

FIGS. 4A-4C show the example body module of FIG. 2C;

FIGS. 5A-5E show various arrangements for an example prime mover output shaft;

FIGS. 6A and 6B show an example leg module;

FIGS. 7A-7C show a thigh of the example leg module of FIGS. 6A and 6B;

FIGS. 7D-7G show an example coupling pair for connecting two robot modules;

FIGS. 7H-7J show an example link set comprised in the coupling pair of FIGS. 7D-7G;

FIGS. 8A-8C show an example coupling pair for connecting two robot modules;

FIG. 8D schematically illustrates an electrical interface between an example leg module and an example body module;

FIGS. 9A-9C show an example coupling pair for connecting two robot modules;

FIGS. 10A-10C show an example first coupling for a leg module;

FIGS. 11A-11D show an example second coupling for a body module;

FIGS. 12A-12B show an example leg module being connected to an example gaming robot;

FIGS. 12C-12D show an example connected coupling pair;

FIGS. 13A-13D show an example leg module and an example shield secondary module;

FIG. 13E illustrates an electrical interface between an example leg module and an example shield secondary module;

FIG. 13F illustrates an example data packet format for transmitting data between an example secondary module and an example primary module;

FIGS. 14A-14C show an example leg module and an example shield secondary module;

FIGS. 15A-15D shows a further example modular gaming robot;

FIGS. 15E-15F shows a further example modular gaming robot;

FIG. 16A shows a further example modular gaming robot;

FIG. 16B shows a further example modular gaming robot;

FIG. 17A shows a further example modular gaming robot;

FIGS. 17B and 17C show a locomotion module of the example gaming robot of FIG. 17A;

FIG. 18A shows a further example modular gaming robot;

FIG. 18B shows a locomotion module of the example gaming robot of FIG. 18A;

FIGS. 19A-19D show various different weapon secondary modules for an example gaming robot;

FIGS. 19E-19G show example coupling pairs for various different weapon secondary modules for an example gaming robot;

FIG. 20 shows two gaming robots being controlled by two users;

FIGS. 21A and 21B show an example remote computing device for controlling a gaming robot;

FIG. 21C shows further example remote computing devices for controlling a gaming robot;

FIG. 22 is a schematic diagram of an example architecture for a gaming robot communication infrastructure;

FIG. 23 is a schematic diagram of an example system architecture for a gaming robot;

FIG. 24 is a schematic diagram of the systems of an example gaming robot main processing module;

FIG. 25 is a schematic diagram of an example system architecture for a remote computing device for controlling a gaming robot;

FIG. 26 is a schematic diagram of the systems of an example remote computing device for controlling a gaming robot;

FIG. 27 is schematic diagram of an example architecture of a cloud-based computing system for use with a gaming robot;

FIG. 28A shows an example gaming robot system;

FIG. 28B is a schematic diagram of an example system architecture of the example gaming robot system of FIG. 28A; and

FIG. 29 is a flow chart illustrating an example method of connecting a module to a gaming robot.

### DETAILED DESCRIPTION OF CERTAIN INVENTIVE EMBODIMENTS

The following description relates to gaming robots (and associated components and systems), which comprise at least one movable joint actuated by a prime mover. Such a gaming robot may be modular and may comprise, for example, a first module comprising first electronic circuitry and a first coupling and a second module comprising second electronic circuitry and a second coupling. The first coupling may be connectable to the second coupling to create a mechanical interface between the first module and the second module and an electrical interface between the first module and the second module. The first electronic circuitry may be configured to, in response to a connection of the second module to the first module, access via the electrical interface data stored within the second electronic circuitry. Said data may identify the second module. The first electronic circuitry may be further configured to transmit the data to an identification system configured to detect the presence and identification of modules attached to the gaming robot. The example gaming robots described herein may, but need not, be remotely controllable, e.g. by one or more remote computing devices.

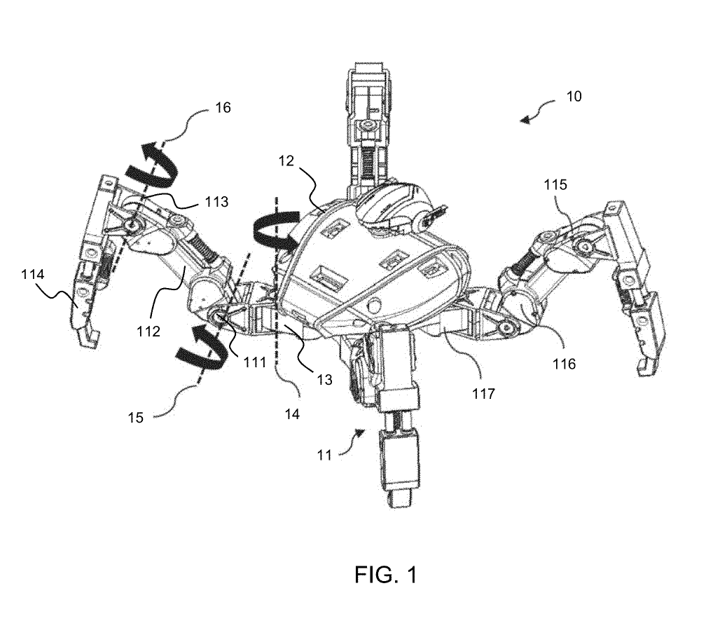

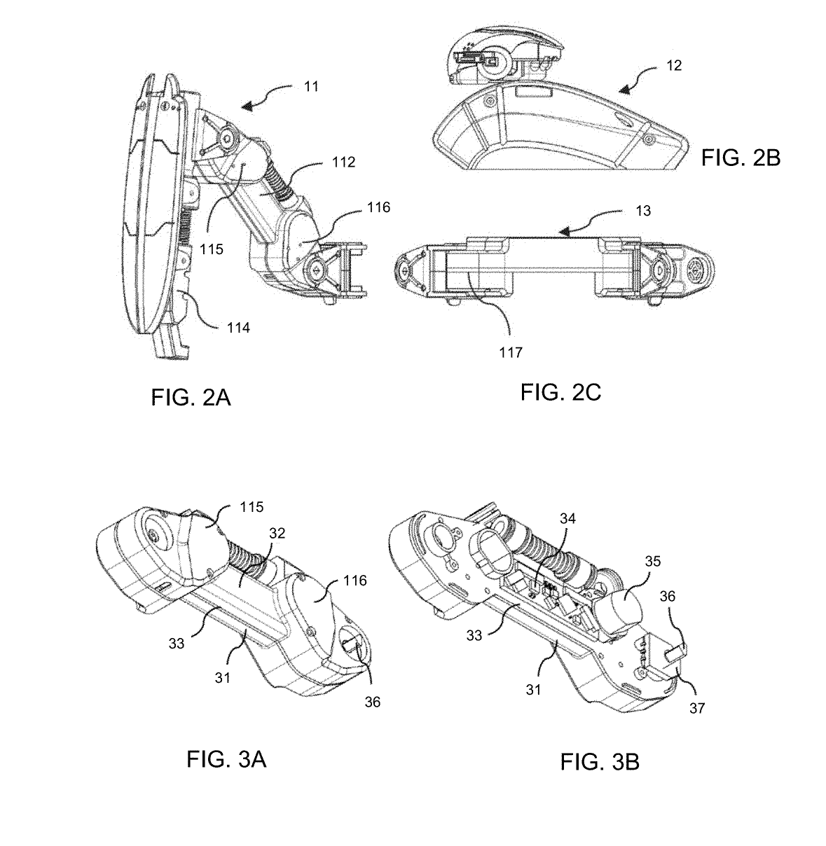

FIG. 1 shows an example robot 10. The robot 10 is a legged robot having four identical legs. The robot 10 is modular, and comprises six modules of three distinct types. The modules comprise four locomotion modules (which in this example are leg modules 11), one main module 12 and one body module 13. FIGS. 2A-2C show each type of module 11, 12, 13 (leg, main and body) separately. In particular, FIG. 2A shows the leg module 11, FIG. 2B shows the main module 12, and FIG. 2C shows the body module 13.

Locomotion modules provide robot motion, which in the case of leg modules 11 may take the form of walking, running, jumping, and the like. The body module 13 provides connection points (couplings) for the locomotion modules and for the main module 12. Each coupling on the body module 13 is connectable to a corresponding coupling on a leg module and/or a corresponding coupling on the main module to create a mechanical interface and an electrical interface therebetween. In the illustrated example the body module 13 houses prime movers to actuate at least one joint of each leg module 11. The main module 12 contains the main controller (main processing module) of the robot 10. The robot 10 is controllable by a remote computing device (not shown) and the main processing module is configured to control at least one other module of the robot 10 in response to commands received from the remote computing device.

Each module 11, 12, 13 comprises electronic circuitry. The modules 11, 12, 13, may therefore be considered to be “smart”. The electronic circuitry may vary in complexity and configuration dependent on module type. For example, the main processing module comprised in the main module 12 may be significantly more complex than the electronic circuitry comprised in the leg modules 11 and in the body module 13. The electronic circuitry of each locomotion module 11 and the body module 13 stores data identifying that module. In some examples the electronic circuitry of the main module 12 also stores data identifying that module. Such data may be used, for example, in a process of authenticating a module upon connection of that module to the rest of the robot, as will be discussed in more detail below. The data identifying the module may comprise a unique identifier associated with the module. The data identifying the module may comprise an indication of the type of the module (e.g. whether it is a locomotion module, a secondary module, a shield module, a weapon module, a body module, etc.). In some examples the data identifying the module is encrypted. In some examples the data identifying the module is configured to be cross referenced with a database, e.g. by the main processing module of the robot, during a process of identifying and verifying the authenticity of the module. In some examples the electronic circuitry also stores calibration data for the module. Such calibration data may, for example, be transmitted to the main processing module upon connection of a module to the robot to enable the main module to determine how the newly-connected module varies from the perfect, and to compensate for any such variations.

The electronic circuitry allows for the identification of the module in which it is comprised either by active means (such as digital or analogue wired electrical connection) or by passive means (such as wireless radiofrequency transmission). Identification of, and verification of the authenticity of, the various modules may be useful in a number of ways, as will be described in more detail below.

Identifying a newly-connected module may comprise, for example, transmitting a data packet from the electronic circuitry of a first module (first electronic circuitry) to the electronic circuitry of a second module (second electronic circuitry), via an electrical interface between the first module and the second module. The data packet may have a particular format, which may depend on the nature of the second module. For example, a different data packet format may be used for secondary module identifying data than for leg module identifying data. An example data packet format may comprise any or all of an identifier, a type string, and a feature list. Each item of data comprised in the data packet may be a fixed length (e.g. a fixed number of bits) or may be variable length data structure marked by start and stop bit sequences. An identifier comprised in a data packet format may be a globally unique identifier for the second module. An identifier may be a 16, 32 or 64-bit sequence, such as an integer, or may comprise a 256, 512 or larger bit sequence representing an encrypted value or result of a cryptographic function. A type string may be used by the main processing module to determine a module type so as to retrieve corresponding control routines to control said module. In certain cases the data packet format may not include a type string, for example in cases where control information may be alternatively retrieved based on a look-up operation by main processing module using an identifier. A feature list may indicate which, if any, controllable components are comprised in the second module. For example, a string value “LEDR” comprised in the features list may indicate that the second module comprises a red LED and that control values for this LED should be provided as a first data item; a string value “LEDB” may indicate that the second module comprises a blue LED and that control values for this LED should be provided as a second data item; and a string value “MOTOR1” may indicate that the second module comprises a motor and that control values for this motor should be provided as a third data item.

Example data 1073 may be read by the first electronic circuitry from a memory of the second electronic circuitry. Example data 1073 may be read by the first electronic circuitry in response to a request received by the first electronic circuitry from the main processing module (e.g. if the first electronic circuitry is comprised in a module other than the main module 12). The first electronic circuitry may transmit the data 1073 to the main processing module. The main processing module may transmits this data to a coupled computing device to set attributes of the gaming robot. If a computing device is not connected then the main processing module 210 may cache this data for later transmission. For example, a simulated mass of the gaming robot may be set based on the “HVY” type 2712 or based on a lookup using the identifier 2711 (e.g. the type may be implicit in the identifier).

Example data 274 may be sent to the second module from the main processing module 210 via the first electronic circuitry and the second electronic circuitry as a data packet to control the active electronic components set out in feature list 2703. Example data, in this case, comprises three 8-bit data values that are received serially by a microcontroller of the second module (the values being “35”, “128” and “12”). The value “35” controls a level of the red LED identified by item 2714; the value “128” controls a level of the blue LED identified by item 2715; and value “12” controls a position or speed of the motor identified by item 2716.

Each leg module 11 comprises a hip 111, a thigh 112, a knee 113, and a lower leg 114. Each of the legs is actuated by three prime movers 115, 116 and 117, which in this example are each fully integrated within the robot 10. Each of the prime movers actuates a different movable joint of a leg module 11. The hip 111 of each leg module comprises two such movable joints, which are configured to pivot about orthogonal axes. The knee 113 of each leg module comprises a further such movable joint, which is configured to pivot about an axis parallel to the pivotal axis of the nearest hip joint (that is, the hip joint nearest to the knee joint). Each of the prime movers 115, 116 and 117 thereby confers to each leg three degrees of freedom, allowing the leg to rotate about three axes of rotation 14, 15 and 16. Two prime movers 115, 116 are integrated into each thigh 112. The remaining prime movers 117 are contained in the body module 13. The number of prime movers 117 comprised in the body module 13 corresponds to a maximum number of legs that may be comprised in the robot 10. The prime movers 117 are controlled by commands generated by the main processing module and transmitted across the electrical interface between the main module 12 and the body module 13 (and, for a prime mover comprised in a leg module 11, across the electrical interface between the body module 13 and that leg module). Such commands may, for example, be low-level commands which are generated by the main processing module in response to high-level commands received by the main processing module from the remote computing device.

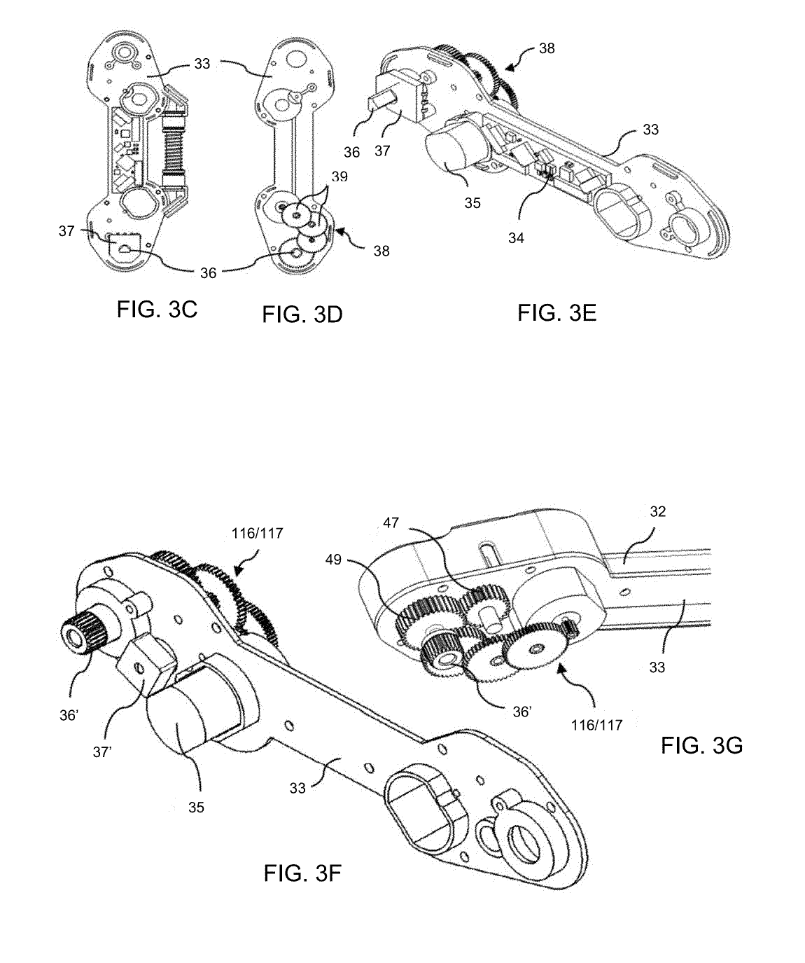

FIGS. 3A-F show the thigh 112 of an example leg module 11, and the two prime movers 115, 116 comprised therein, in more detail. In this embodiment, the thigh 112 is formed of three main structural components—two outer shells 31 and 32 and a thigh carrier plate 33. FIG. 3B shows the thigh 112 with the shell 32 removed, to show the carrier plate 33 more clearly. For clarity only the components of one prime mover 115 are illustrated (prime mover 116 is intentionally omitted). It can be seen from FIGS. 3C-3E that the thigh carrier plate 33 provides a mechanical interface with the components of the prime mover 115. In the particular illustrated example the components of the prime mover 115 comprise a thigh electronics board 34 arranged to drive both prime movers 115 and 116 independently, a motor 35, an output shaft 36, and a position sensor 37. The thigh electronics board 34 is comprised in the electronic circuitry of the leg module 11. Prime mover 115 also includes a gearbox 38 (visible in FIGS. 3D and 3E) comprising gears 39 to mechanically gear the output torque of motor 35.

FIGS. 3C-3E provide a further detailed view of the prime mover 115 of thigh 112 with both shells 31 and 32 removed. The power train of prime mover 115 comprises the motor 35 and, in this particular example, a four stage parallel axis gearbox 38 with an overall gearing ratio of approximately 320:1. The control of prime mover 115 is governed by the thigh electronic board 34 and the position sensor 37. Mirrored version of the components of the prime mover 115 may be provided at the opposite end of the thigh 112 to form prime mover 116.

FIGS. 3F and 3G show an alternative arrangement for the position sensor. The position sensor 37 depicted in FIGS. 3A-3E is a type of position sensor known as “through-hole” or “shaft-less”, which is designed to allow a shaft, in this case the prime movers output shaft 36, to pass through the position sensor 37. This facilitates a dual output shaft design. However; an alternative arrangement (that is, the arrangement shown in FIG. 3F) is also possible in which a position sensor 37′ relies on an idler gear 47 that meshes with a gear 49 of an output shaft 36′. In the example depicted, the idler gear 47 has a smaller pitch diameter than gear 49 which helps improve the sensitivity of position sensor 37′. A gearing ratio of 1:1 between gear 49 and idler 47 may however be preferable if the range of motion of the position sensor 37′ is limited.

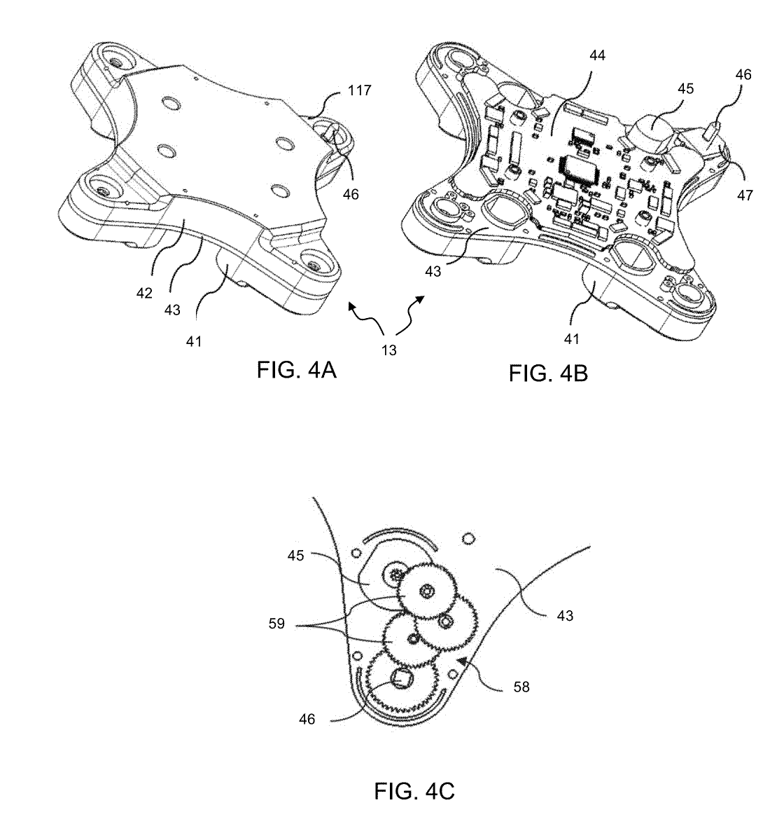

FIGS. 4A and 4B provide a detailed view of the integrated body module 12 and one of its four prime movers 117. For clarity the other three prime movers housed within the body module 12 are not depicted. The construction of the body module 12 is similar to the construction of the thigh 112, with the exception that the thigh 112 houses two prime movers whereas the body module 12 houses four prime movers. The body module 12 is formed of three main structural components—two outer shells 41 and 42 and a body carrier plate 43. FIG. 4B depicts the body module 12 with shell 42 removed. For clarity only the components of one prime mover 117 are illustrated (the other three prime movers 117 are intentionally omitted).

The body carrier plate carrier 43 provides a mechanical interface with the components of the prime movers 117. The prime mover components shown in FIGS. 4A and 4B are a body electronics board 44 that is arranged to drive all four body prime movers 117 independently, a motor 45 of prime mover 42, a body output shaft 46, and a position sensor 47. It should be noted that in this particular embodiment, and to reduce the cost of manufacture, the components of the prime movers 117 are identical to the corresponding components of the prime movers 115 and 116 in the thigh. The prime mover 117 also includes a gearbox (visible in FIG. 4C) to mechanically gear the output torque of the motor 45. The components of the illustrated prime mover 117 may be duplicated to form the remaining three prime movers 117 of the body module.

FIG. 4C provides a further detailed view of the gearbox 58 of one of the four prime movers 117 of the body module 12 with both shells 41, 42 removed. The power train of prime mover 117 comprises a motor 45 and in this particular example a four stage gearbox 58 comprising four parallel axis gears 59 with an overall gearing ratio of approximately 320:1 and an output torque of approximately 0.5 Nm.

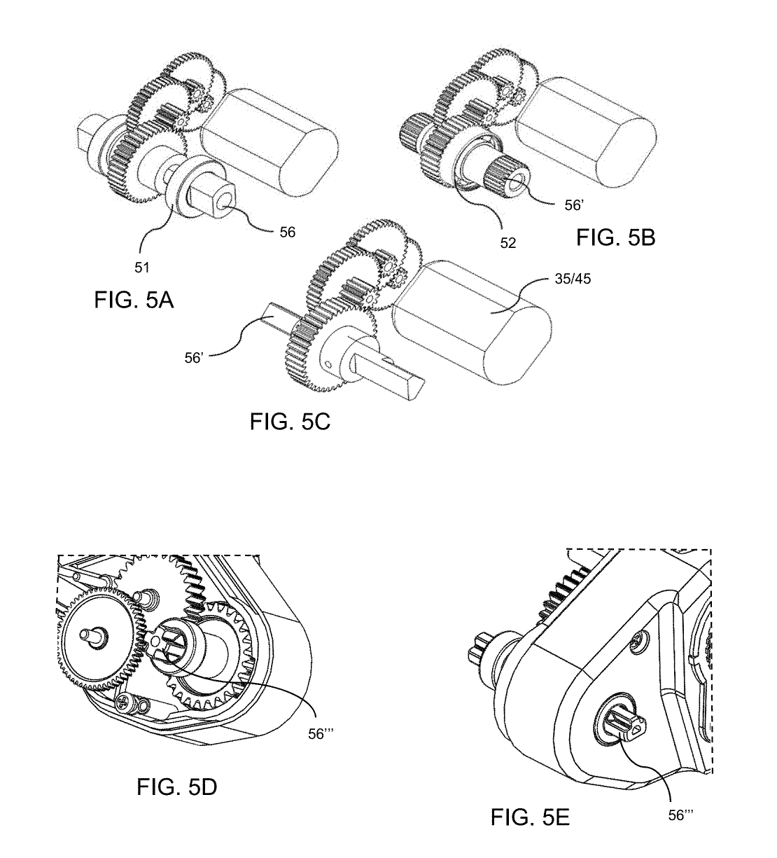

FIGS. 5A-5E detail various arrangements of the output shaft of the prime movers 115, 116 and 116 found in the thigh 112 and the body module 13. In particular, FIGS. 5A-5E show different possible configurations of a coupling and a bearing for a first example output shaft 56. FIG. 5A depicts how one or more bushings 51 are used inside a thigh or body module (not depicted) to support the first example output shaft 56. In this example the output shaft 56 comprises a type of spline known as a parallel key spline. FIG. 5B shows one or more ball-bearings 52 being used inside the thigh 112 or body modules 13 (not depicted) to support a second example output shaft 56′. The second example output shaft 56′ comprises a type of spline known as an involute spline. FIG. 5C shows a third example output shaft 56″ which comprises a type of spline known as a parallel key spline. FIGS. 5D and 5E are two different views of a fourth example output shaft 56′″. The fourth example output shaft 56′″ has a +-shaped cross-section at one end (the end visible in FIG. 5D) and a T-shaped cross-section at the other end. The prime movers 115, 116, 117 may comprise output shafts having the features of any of the first, second or third example output shafts 56, 56′, 56″, or any other suitable output shaft arrangement.

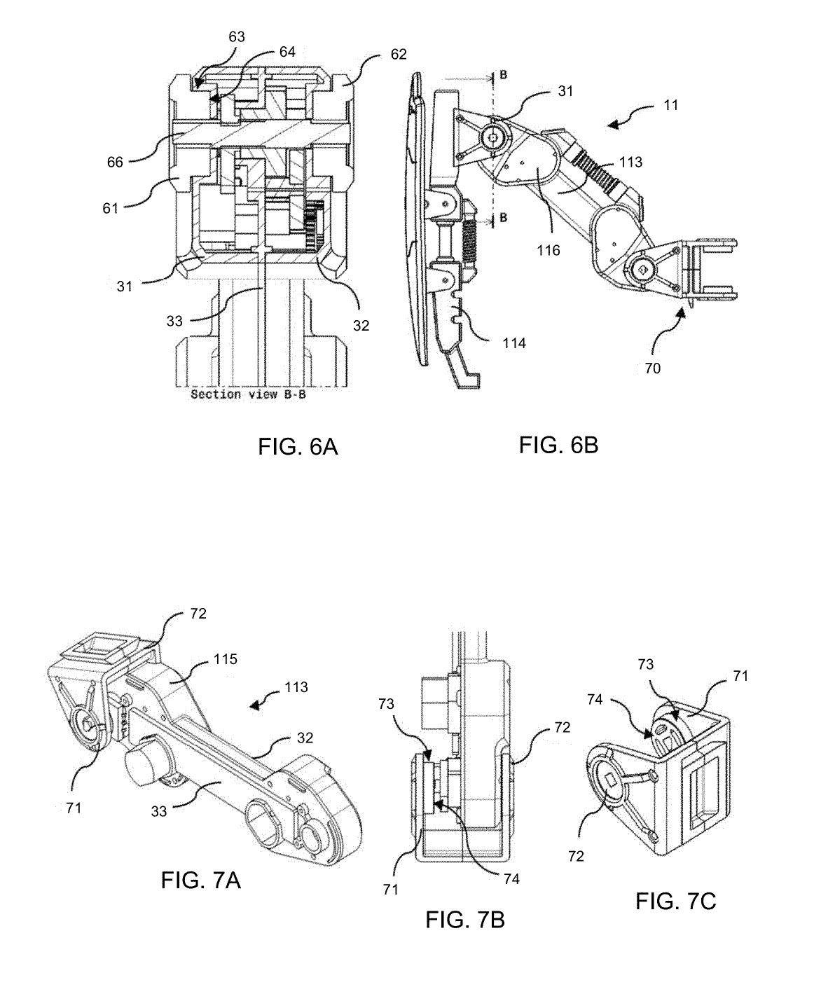

FIGS. 6A and 6B illustrate an alternative arrangement of a leg module 11 in which no ball bearings and no bushings are used inside the leg module 11 (similarly, no ball bearings and no bushings may be used inside the body module 13). Instead, links 61 and 62, which are comprised in a coupling to connect the thigh 112 to the lower leg 114, also act as bearing surfaces. FIG. 6A shows a cross-section of a thigh 112 and a lower leg 116, from which it can be seen that the link 61 is keyed onto an output shaft 66 of a prime mover (e.g. the prime mover 115). The links 61 and 62 provide a bearing surface 63 for radial load and a bearing surface 64 for axial load by bearing against thigh shells 31 and 32. FIGS. 6A and 6B also depict a coupling pair 70 (which in this example comprises a set of links) at the opposite end of the thigh 112. The coupling pair 70 is used to mechanically interface the leg module 11 with the body module 13. The coupling pair 70 may also electrically interface the leg module 11 with the body module 13.

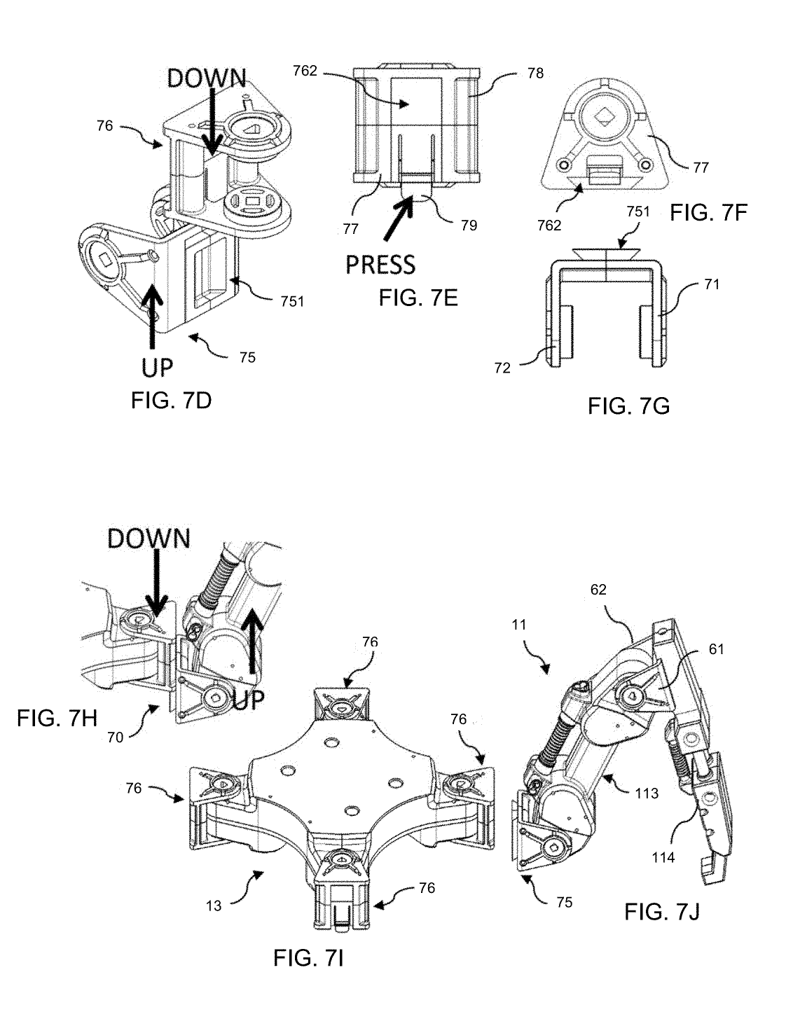

FIGS. 7A-7C provide a view of thigh 112 with only one prime mover 115 illustrated for clarity. In a similar arrangement to the links 61 and 62 for connecting the thigh 112 to the lower leg 114, FIGS. 7A-7C show a pair of links 71 and 72 for connecting the thigh 112 to the body module 13. In this particular embodiment the links 71, 72, provide bearing surfaces 73 and 74, which are similar to the bearing surfaces 63 and 64 provided by the links 61 and 62.

Various examples of coupling pairs for connecting two modules of a modular gaming robot will now be described. In general, each example coupling pair comprises a first coupling having a first set of electrical contacts and a first connection surface shaped to create a first set of formations; and a second coupling having a second set of electrical contacts for cooperating with the first set of electrical contacts to create an electrical interface when the two modules are connected and a second connection surface shaped to create a second set of formations. At least one of the two modules (that is, the two modules connectable by means of the coupling pair) forms part of a pivoting joint of the modular robot. The first set of formations and the second set of formations are configured such that movement of the first coupling into engagement with the second coupling along a connection axis substantially normal to the first connection surface creates a mechanical interface between the first coupling and the second coupling which resists further relative movement of the first coupling and the second coupling along the connection axis. The mechanical interface also resists rotational movement of the first coupling relative to the second coupling around an axis parallel to the pivotal axis of the pivoting joint.

FIGS. 7D-7G show various views of the example coupling pair 70. The coupling pair 70 connects the leg module 11 to the body module 13 and comprises of two couplings 75 and 76. In this example, each coupling 75, 76 comprises a pair of links. The coupling 75 forms part of the leg module 11 and mechanically interfaces with one of the prime movers 116, 115 of each thigh 112. The coupling 75 (which may be considered to be a first coupling) comprises of individual links 71 and 72. The coupling 76 (which may be considered to be a second coupling) forms part of the body module 13 and mechanically interfaces with the output shaft of any of the four prime movers 117 of the body module 13. The coupling 76 comprises individual links 77 and 78. In the embodiment of the coupling pair 70 depicted in FIGS. 7D-7G, the couplings 75 and 76 can be decoupled (or disengaged/disconnected) by pressing on a spring latch 78 to allow a key 751 (which may be considered to be comprised in a first set of formations created by a first connection surface) of coupling 75 to engage with keyway 762 (which may be considered to be comprised in a second set of formations created by a second connection surface) of coupling 76. In this particular embodiment coupling 75 engages (or respectively disengages) from coupling 75 in an upward (or respectively downward motion). Spring latch 78 is designed to flex when pressed (to engage or disengage coupling 75 from coupling 76) and to spring back into its original position to retain coupling 75 and coupling 76 in engagement. The link set 70 may therefore be considered to be a quick-release or quick-disconnect link set.

FIGS. 7H-7J further illustrates the link set 70. FIG. 7I depicts the body module 13 with all four couplings 76 providing a mechanical interface with all four prime movers 117 of body module 13. FIG. 7J depicts one of the four leg modules 11, comprising a coupling 75 which provides a mechanical interface with one of the thigh prime movers. The other thigh prime mover of the leg module 11 mechanically interfaces with the lower leg 114 via a pair of lower leg links 61 and 62. FIG. 7H shows the body module 13 and the leg module 11 in a partially connected state. A link set which creates a mechanical interface in the manner of the link set 70 may also include features which form an electrical interface when the couplings 75 and 76 are in a connected state (not shown in FIGS. 7A-J).

It can be seen from FIGS. 9A and 9B that the first coupling 95 comprises a connection surface shaped to create the key 751, which has the form of protrusion, and that the second coupling 96 comprises a connection surface shaped to create the keyway 762, which has the form of a recess. The key 751 and the keyway 762 are mutually configured such that the key 751 may be slid into the keyway 762 by aligning the key 751 with an open end of the keyway 762 and relatively moving the first and second couplings 75, 76 towards each other along a direction perpendicular to the connection surfaces of the couplings. The configuration (e.g. the shape) of the key 751 and the keyway 762 is such that when the key 751 is engaged with the keyway 762, a mechanical interface is created between the first and second couplings 75, 76 which resists relative movement of the first coupling and the second coupling along a connection axis perpendicular to each of the connection surfaces. Each of the first and second couplings 75, 76 is also configured to form part of a pivoting joint of the module in which that coupling is comprised. The mechanical interface formed between the first and second couplings as described above also resists rotational movement of the first coupling relative to the second coupling around an axis parallel to the pivotal axis of each of these pivoting joints.

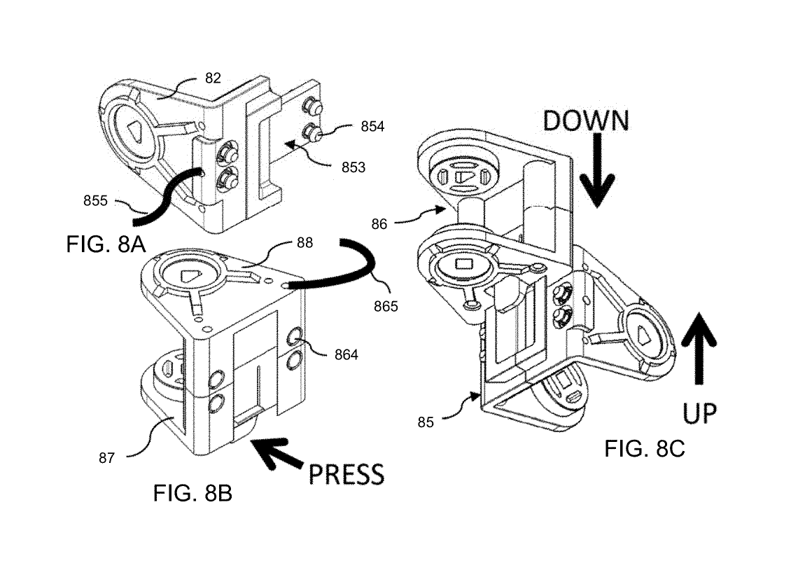

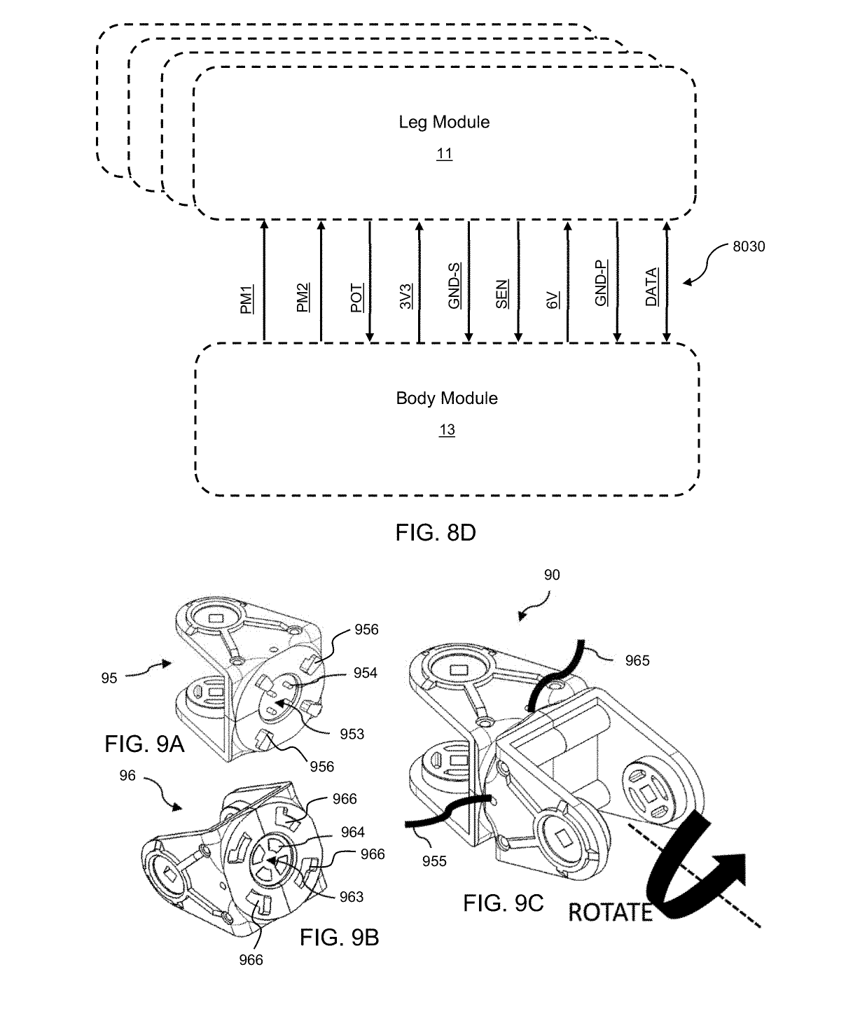

FIGS. 8A-8C illustrate how such an electrical interface may be formed simultaneously with forming a mechanical interface in the manner described above in relation to FIGS. 7D-J. FIGS. 8A-8C show a coupling pair 80, which comprises a first coupling 85 comprising a first link (not shown) and a second link 82, and a second coupling 86 comprising a first link 87 and a second link 88. The components of the coupling pair 80 may have any or all of the features of the corresponding components of the coupling pair 70 described above. In the particular illustrated embodiment, coupling 85 includes a printed circuit board 853 retained between both of its links, although for clarity only link 82 is depicted. The printed circuit board 853 forms at least part of the electronic circuitry of a leg module in which the coupling 85 is comprised. Printed circuit board 853 comprises, in this example, four spring loaded pins 854 that act as electrical connectors. The pins 854 may be considered to comprise a first set of electrical contacts. Printed circuit board 853 is wired to thigh printed circuit board 34 with electrical cables 855. Similarly, coupling 86 includes printed circuit boards (not depicted) retained between both of its links 87 and 88. The printed circuit boards of the coupling 86 form at least part of the electronic circuitry of the body module in which the coupling 86 is comprised. The printed circuit boards of coupling 86 comprise, in this example, four electrical pads 864 designed to make electrical contact with pins 854. The electrical pads 864 may be considered to comprise a second set of electrical contacts. The printed circuit boards of coupling 86 (not depicted) are wired to the body module printed circuit board 44 with electrical cables 865.

FIG. 8D schematically illustrates the electrical connections comprised in an electrical interface between example first and second modules of the gaming robot 10 (e.g. the electrical interface created by the first coupling 85 and the second coupling 86). In the illustrated example the first module is a locomotion module (e.g. the leg module 11) and the second module is a body module (e.g. the body module 13).

FIG. 8D shows the body module 13 electrically coupled to the leg module 11. The connections may be duplicated in respect of each separate leg module connected to the body module 13. The connections may form part of a body-to-leg module interface. In FIG. 8D, the leg module includes two thigh prime movers and the body module includes a hip prime mover for each leg module, as described above. In other cases the leg module may include the thigh prime movers and the hip prime mover. FIG. 8D shows ten separate electrical connections 260: PM1—a connection for a first prime mover control signal; PM2—a connection for a second prime mover control signal; POT—a connection for a position feedback signal; 3V3—a 3.3 Volt direct current power supply; GND-S—a ground channel for the 3.3 V supply; SEN—a connection for a sensing channel indicating the presence of a leg module; 6V—a 6 Volt direct current power supply; GND-P—a ground channel for the 6 V supply; and DATA—a connection for a serial data communication channel One of PM1-3 may carry a PWM signal to control a motor for thigh rotation (e.g. about axis 15); and another of PM1-2 may carry a PWM signal to control a motor for foot rotation (e.g. about axis 16). In certain cases, the signals may directly control the prime mover; in other cases one or more of the signals may comprise control data for a thigh MCU, wherein the MCU computes a PWM signal from said control data. The POT connection may carry position data from each of the position sensors on the leg module (e.g. supplied serially). Alternatively, three separate channels may be provided in other implementations. The 3V3 and 6V connections, and the corresponding GND return connections may be used to power the prime movers and one or more active electronic components (e.g. motors or LEDs on secondary modules). The SEN connection may be used by the main processing module 210 to detect the presence of a leg module 11. In a simple case, the SEN connection may simply be a return for the 3V3 power supply. Hence, when no leg module 11 is attached there is no voltage on this connection, however when the leg module 11 is attached the SEN connection is raised to a voltage of 3V3 (or below). The DATA channel may be used to obtain data identifying the leg modules and data identifying any attached secondary modules. It may also be used to send other commands and requests to the control logic of the leg module 11. The DATA channel may be a UART or other serial data channel. The DATA channel may also communicate data between the electronic circuitry of the first and second modules. The DATA channel may also be used for firmware upgrades.

FIGS. 9A-9C illustrate another example coupling pair 90 for creating a quick-release mechanical and electric connection between two modules of a gaming robot. The coupling pair 90 comprises a first coupling 95 (which comprises a first link and a second link) and a second coupling 96 (which comprises a first link and a second link). In this particular embodiment, coupling 95 includes a printed circuit board 953 retained between both of its links. Printed circuit board 953 is comprised in the electronic circuitry of a leg module 11. Printed circuit board 953 comprises, in this example, four spring loaded pins 954 that act as electrical connectors. The pins 954 may be considered to comprise a first set of electrical contacts. Printed circuit board 953 is wired to the printed circuit board 34 of the thigh 112 with electrical cables 955. Similarly, coupling 96 includes printed circuit boards 963 retained between both of its links. The printed circuit boards 963 are comprised in the electronic circuitry of the body module 13. The printed circuit boards 963 of the coupling 96 comprise, in this example, four electrical pads 964 configured to make electrical contact with pins 954. The electrical pads 964 may be considered to comprise a second set of electrical contacts. The printed circuit boards 963 are wired to the printed circuit board 44 of the body module 13 with cables 965. In this particular example, the couplings 95 and 96 are connected/disconnected by twisting (rotating) one of the couplings 95, 96 about the other one of the couplings 95, 96 (as indicated by the arrow in FIG. 9C).

It can be seen from FIGS. 9A and 9B that the first coupling 95 comprises a connection surface shaped to create four protrusions 956 (which may be considered to comprise a first set of formations) and that the second coupling 96 comprises a connection surface shaped to create four recesses 966 (which may be considered to comprise a second set of formations). The protrusions 956 and the recesses 966 are mutually configured such that, in a first relative orientation of the first coupling 95 and the second coupling 96, the protrusions 956 are receivable into the recesses 966. The configuration (e.g. the shape) of the protrusions 956 and the recesses 966 is such that when the protrusions 956 are received in the recesses 966, a small amount of relative rotation of the first and second couplings 95, 96 is possible in a first direction (but is not possible in a second, opposite direction). Rotating the first coupling about the second coupling (or vice versa) in the first direction forms a mechanical interface between the first and second couplings which resists relative movement of the first coupling and the second coupling along a connection axis perpendicular to each of the connection surfaces. Each of the first and second couplings 95, 96 is also configured to form part of a pivoting joint of the module in which that coupling is comprised. The mechanical interface formed between the first and second couplings as described above also resists rotational movement of the first coupling relative to the second coupling around an axis parallel to the pivotal axis of each of these pivoting joints.

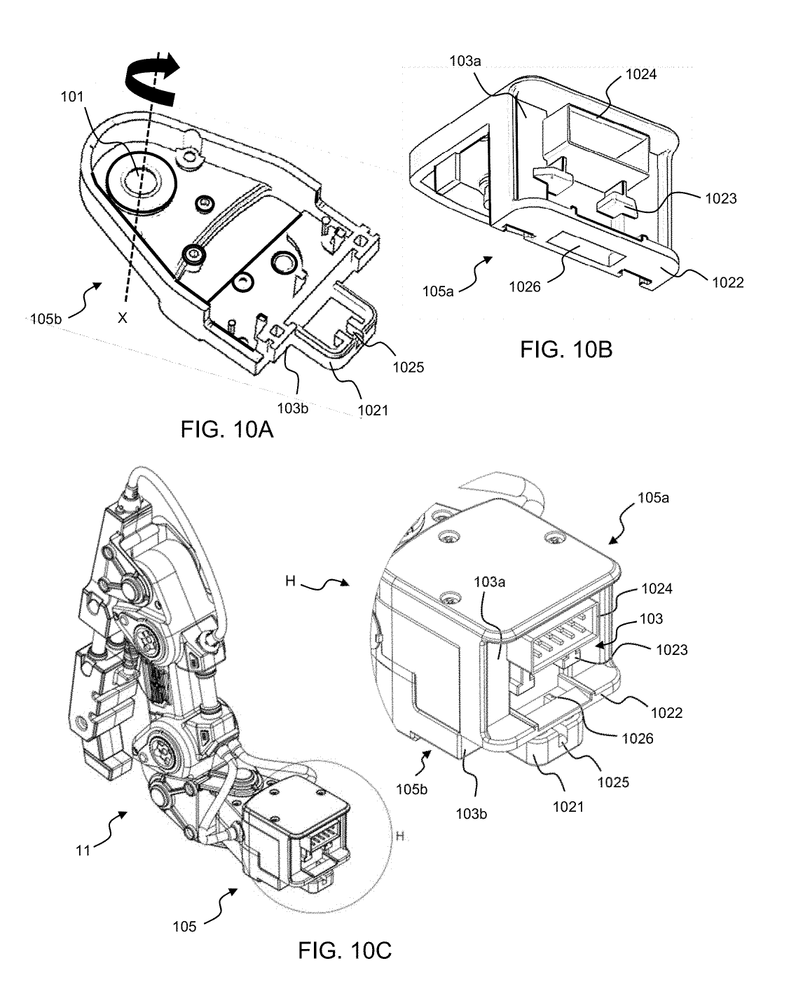

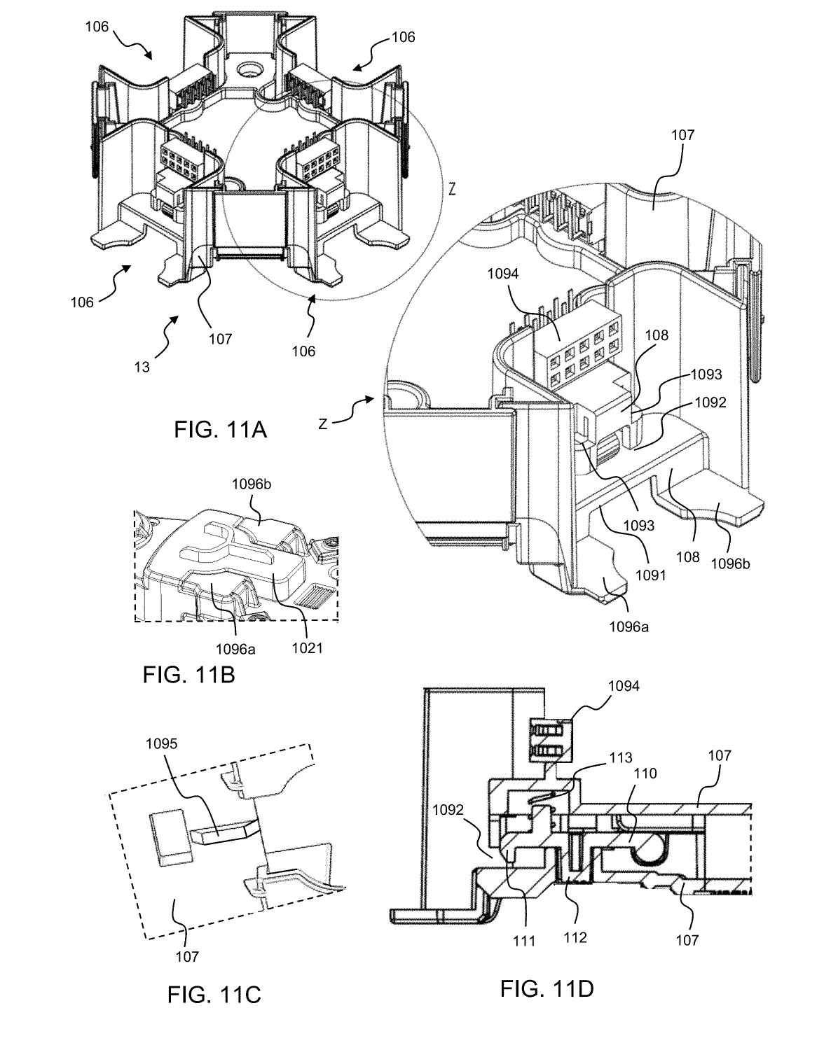

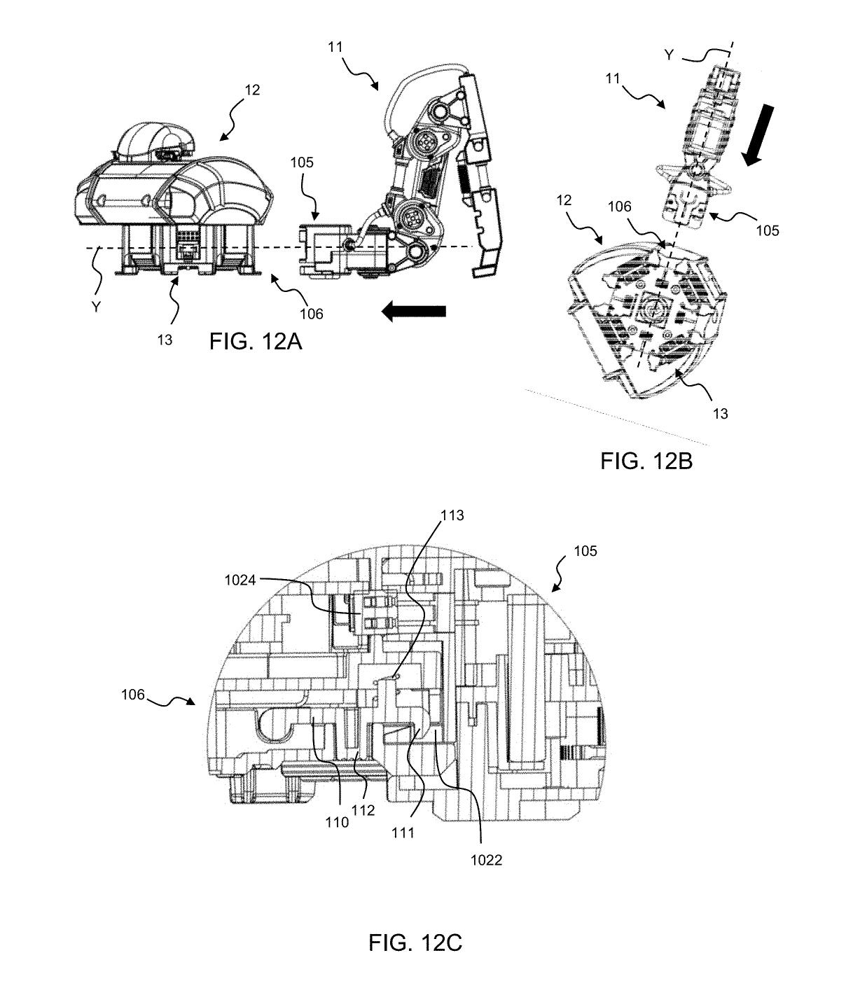

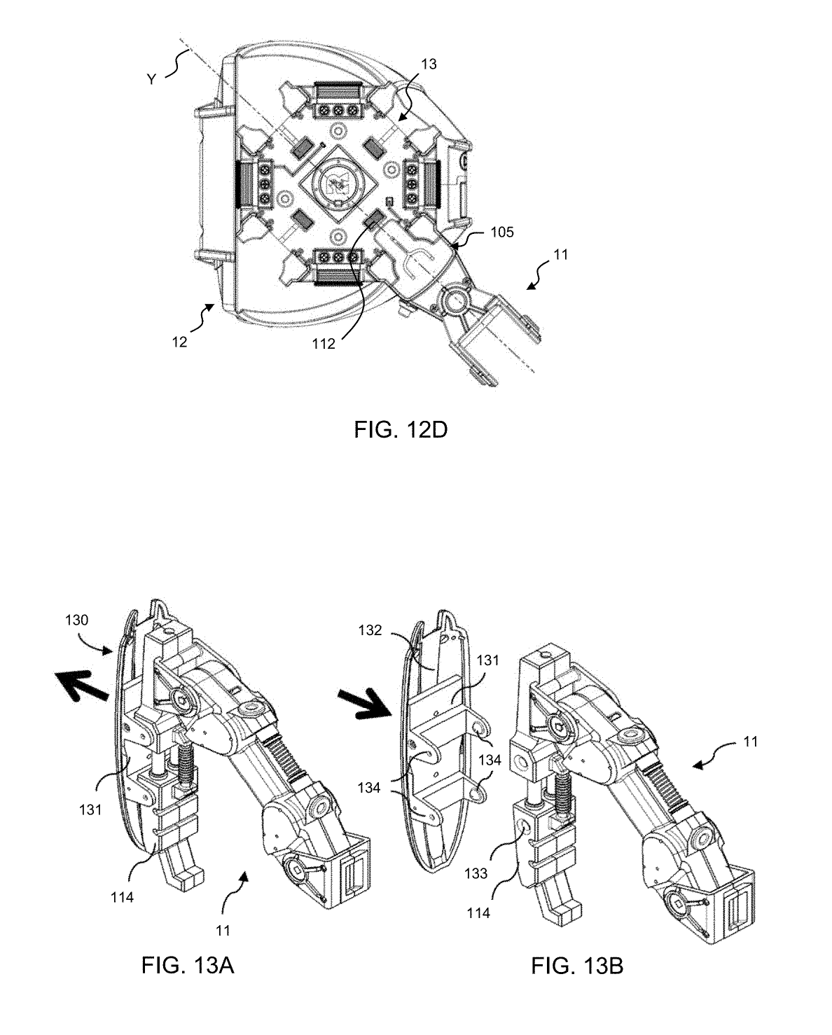

FIGS. 10-12D illustrate a further example coupling pair comprising a first coupling and a second coupling. FIG. 10A shows the first coupling 105, and FIGS. 11A and 11B show the second coupling 106. FIGS. 12A-D show the first and second couplings 105, 106 connected together and during a process of connecting. The terms “first” and “second” as used herein are intended merely to distinguish between the two members of a coupling pair and should not be interpreted as implying any differential features as between the first and second couplings. Moreover, although in the following description the first coupling is comprised in a leg module and the second coupling is comprised in a body module, in principle either of the first and second couplings may be comprised in any module of a modular robot according to the examples.

In the illustrated example the first coupling 105 is configured to be comprised in a leg module (e.g. the leg module 11) of a gaming robot. It should be noted that the cables connecting different parts of the leg module 11 which are shown in FIG. 10C represent an optional way of transmitting electrical power across a movable joint. That is, although such cables are not depicted in the examples shown in FIGS. 1-10, those examples could use cables similar or equivalent to the cables shown in FIG. 10C. Alternatively, some examples may utilize internal routing of power and data signals, such that no external cables are required. The leg module 11 in which the first coupling 105 is comprised forms part of a pivoting joint of the modular robot. In the illustrated example, the first coupling 105 comprises a link 101 which forms part of a pivoting joint having a pivotal axis X.

The first coupling 105 comprises at least an upper part 105a and a lower part 105b, as shown by FIGS. 10A and B. In some examples the first coupling 105 may additionally comprise a middle part between the upper part 105a and the lower part 105b. However; this middle part does not contribute to the connecting function of the first coupling 105 and will therefore not be described further. In use, the upper part 105a is joined to the lower part 105b, as shown in FIG. 10C. The first coupling 105 has a first connection surface 103 formed by the front surface 103a of the upper part 105a and the front surface 103b of the lower part 105b. The connection surface 103 is shaped to create a first set of formations, configured to cooperate with a second set of formations created by a second connection surface on the second coupling, as will be described below. The first set of formations, in this example, comprises a plurality of protrusions each of which extends, relative to an adjacent region of the first connection surface 103, outwardly in a direction that is substantially radial relative to the pivotal axis X of the pivoting joint of which the leg module forms a part.

In the illustrated example the protrusions comprise a tab 1021, a shelf 1022, a pair of lugs 1023, and a socket 1024. The tab 1021 includes a channel 1025 extending into its front face in a direction substantially perpendicular to the connection surface 103. The shelf 1022 includes a recess 1026 which extends into the lower surface of the shelf 1022. In some examples the recess 1026 extends to the upper surface of the shelf 1022, such that the recess 1026 comprises an opening in the shelf 1022. In the illustrated example, the socket 1024 contains a first electrical connector having a first set of electrical contacts in the form of a plurality of pins.

In the illustrated example the second coupling 106 is configured to be comprised in a body module (e.g. the body module 13) of a gaming robot. In the illustrated example the body module 13 comprises four second couplings 106, each of which is formed integrally with a shell 107 of the body module 13. Each second coupling 106 comprises a socket-like feature. A part of the outer surface of the shell 107 is recessed with respect to the adjacent parts of the shell 107 to form the socket-like feature. The surface of the recessed part comprises a connection surface 108 which is shaped to create a second set of formations, configured to cooperate with the first set of formations on the first coupling, as will be described below.

The second set of formations, in this example, comprises a plurality of recesses each of which extends, relative to an adjacent region of the first connection surface 108, inwardly in a direction that is substantially radial relative to the pivotal axis X of the pivoting joint of which the leg module forms a part. Each of the plurality of recesses is shaped to receive a corresponding protrusion of the first coupling. In some examples, one or more of the plurality of recesses may be shaped to match a corresponding protrusion of the first coupling, such that a close fit is achieved between the recess and the corresponding protrusion which functions to substantially prevent relative movement between the recess and the corresponding protrusion, at least in the plane of the connection surfaces, when the protrusion is received in the recess. In the illustrated example the recess 1091 is shaped to receive the tab 1021, the recess 1092 is shaped to receive the shelf 1022, and the pair of recesses 1093 is shaped to receive the pair of lugs 1023.

The second set of formations may further comprise at least one protrusion which extends outwardly relative to an adjacent region of the second connection surface. Such a protrusion may extend in a direction parallel to the pivotal axis of the pivoting joint, and/or in a direction perpendicular to the pivotal axis of the pivotal joint. FIG. 11B shows part of a lower surface of the coupling 107 (with respect to the orientation shown in FIG. 11A) which is not visible in FIG. 11A. In the illustrated example, the second set of formations comprises a linear protrusion 1095 (having a long axis radial to the pivotal axis X of the pivoting joint, which extends from a downward-facing part of the connection surface 108 (that is, the lower surface shown in FIG. 11B) in a direction parallel to the pivotal axis X. The linear protrusion 1095 is configured to be snugly received within the channel 1025 when the first and second couplings 105, 106 are connected. The degree of extension of the linear protrusion 1095 and the channel 1025 in the direction radial to the pivotal axis X provides a relatively large moment arm over which to react twisting forces generated by the pivoting joint, and thereby strongly resists relative movement of the first and second couplings about an axis parallel to the pivotal axis X.

In the illustrated example, the second set of protrusions additionally comprises a pair of tabs 1096a and 1096b which extend outwardly from the connection surface 108 at the bottom of the coupling 106. The tabs 1096a, 1096b are configured to interlock with the tab 1021 on the first coupling 105 in a three-finger locking arrangement, as is shown by FIG. 11B. This three-finger locking arrangement provides a relatively large moment arm over which to react twisting forces generated by the pivoting joint, and thereby strongly resists relative movement of the first and second couplings about an axis parallel to the pivotal axis X.

The effect of the complex complementary shapes of the first and second connection surfaces 103, 108 (i.e. created by the first and second sets of formations) is to provide a large contact area in multiple planes parallel to the pivotal axis X. These contacting surfaces substantially all of the twisting forces generated by the pivoting joint, and prevent all or substantially all relative movement, along all axes (except for movement of the first and second couplings 105, 106 away from each other along the connection axis Y, which is required in order to disconnect the first and second couplings and is instead prevented by the releasable locking mechanism).

The second set of formations further comprises a protrusion in the form of a second electrical connector 1094 which extends outwardly from the second connection surface 108. The second electrical connector 1094 may comprise a set of electrical contacts in the form of a plurality of sockets to receive the plurality of pins of the first electrical connector. The second electrical connector 1094 is shaped to be received within the socket 1024 when the first and second couplings 105, 106 are connected and, when so received, to form an electrical interface with the first electrical connector in the socket 1024. The electrical interface may have any of the features of the electrical interface described above in relation to FIG. 8B. The socket 1024 thereby functions to protect the first and second electrical connectors when the first and second couplings 105, 106 are connected.

The first set of formations on the first coupling and the second set of formations on the second coupling are configured such that movement of the first coupling into engagement with the second coupling along a connection axis Y substantially normal to the first connection surface (and the second connection surface) creates a mechanical interface between the first coupling and the second coupling which resists further relative movement of the first coupling and the second coupling along the connection axis. The mechanical interface may also resist rotational movement of the first coupling relative to the second coupling around an axis parallel to the pivotal axis of the pivoting joint. The resistance to relative movement in a certain direction or directions may be enhanced, in some examples, by the particular shape of the first set of formations and the second set of formations. For example, one or more formations of the first set of formations may be configured to interlock with one or more formations of the second set of formations. One or more formations of the first set of formations may be configured to have an interference fit with one or more formations of the second set of formations. Resistance to relative movement in a certain direction may be enhanced by providing corresponding first and second formations with a significant surface area in a plane perpendicular to the certain direction.

FIGS. 12A-D illustrate a process of connecting a leg module 11 to a robot comprising a body module 11 and a main module 12. FIGS. 12A and 12B show a side view (FIG. 12A) and a top view (FIG. 12B) of the leg module 11 being moved toward the body module 13 along the connection axis Y. The connection axis Y represents an axis along which a user must move the first coupling 105 toward the second coupling 106 (or vice versa) in order to connect the first coupling 105 to the second coupling 106. In some examples (including the illustrated example) the first coupling 105 and the second coupling 106 must be maintained in a particular relative orientation as they are moved toward each other along the connection axis, in order to achieve connection. The relative orientation can be altered by relative rotation of the first and second couplings 105, 106 about the connection axis. FIGS. 12A and 12B show the first coupling 105 and the second coupling 106 in the correct relative orientation to achieve a connection therebetween.

FIG. 12C is a vertical (with respect to the orientation shown in FIG. 12A) cross section through the first and second couplings 105, 106 in a connected state. It can be seen from this figure how the first set of formations engages with the second set of formations, such that the first and second connection surfaces are in close contact. FIG. 12D shows the bottom surfaces of the leg module 11 and the robot comprising the body module 13 and the main module 12, in the connected state and further illustrates the engagement between the first and second couplings 105, 106.

In some examples, one of the first coupling and the second coupling comprises a locking member having a biasing mechanism to resiliently bias the locking member into a locking position, and the other of the first coupling and the second coupling comprises a locking formation shaped to engage with the locking member when the two modules are connected and the locking member is in the locking position. FIG. 11C is a vertical (with respect to the orientation shown in FIGS. 11A and 12A) cross-section through the center of the second coupling 106 which shows such a locking member.

In the illustrated example, the set of second formations, on the second coupling 106, comprises a locking member in the form of a pivoting latch 110, and the recess 1026 in the shelf 1022 of the first coupling 105 functions as a locking formation. A first end of the latch 110 comprises a hook feature 111 and a second, opposite end of the latch 110 comprises a push button 112. The push button 112 is accessible from an external surface of the second coupling 106. In the illustrated example the push button 112 is accessible from a bottom external surface of a part of the body module in which the second coupling is comprised, through an opening in the shell 107 (as can be seen in FIG. 12D). The latch 110 is biased by a biasing mechanism 113 (which in this example comprises a spring) into a locking position in which the hook feature 111 extends into the recess 1092. When the first coupling 105 is connected to the second coupling 106 the shelf 1022 is received in the recess 1092, and the latch 110 is in the locking position such that the hook feature 111 engages with the recess 1026 in the shelf 1022. The engagement of the hook feature 11 with the recess 1026 can be seen in FIG. 12C. It is apparent from this figure how this engagement functions to prevent the first and second couplings from moving away from each other in the direction of the connection axis Y.

As discussed above, connection of the first coupling 105 to the second coupling 106 is effected by moving the first and second couplings into engagement with each other along the connection axis Y. The latch 110 is configured (shaped) such that it is caused to move out of the locking position by movement of the first coupling into engagement with the second coupling along the connection axis, and is caused to move back into the locking position by the biasing mechanism (which may be, for example, a spring) when the first coupling is engaged with the second coupling. In the illustrated example this is achieved by the latch 110 having a curved front (with respect to a direction of movement during the connection process) surface, as can be seen from FIG. 11C. The engagement of the hook feature 111 with the recess 1026 when the first and second couplings are connected functions to resist relative movement of the first and second couplings along the connection axis.

The latch 110 is attached to the shell 107 such that pressing the push button 112 towards the shell 107 moves the hook feature 111 out of the recess 1026. The push button 112 thereby functions as a release mechanism to disengage the latch 110 from the recess 1026 and thereby enable relative movement of the first and second couplings along the connection axis.

One or more of the modules comprised in a gaming robot according to the examples (e.g. the gaming robot 10) may comprise “secondary modules”. The term secondary is used to indicate that these modules are not essential to the operation of the robot and may be removed and/or interchanged without affecting the core functions of the robot (core functions include locomotion of the robot and communication with the remote computing device). Secondary modules may include shield modules, weapon modules, or any other type of module that may be added to/removed from the robot without affecting its core functions. A secondary module may comprise electronic circuitry storing data identifying that secondary module, which may be used, for example, in a process of authenticating that secondary module when it is connected to a robot. A secondary module comprises a coupling connectable to a corresponding coupling on another module of the robot to form a mechanical interface between the secondary module and the other module, and an electrical interface between the secondary module and the other module. An electrical interface between a secondary module and another module of the robot may have any of the features of the electrical interfaces between robot modules described above in relation to the robot 10. A secondary module may comprise a controllable electronic component (such as a light, a speaker, a display, a memory, an actuator, etc.), in which case the other module may be configured to transmit commands for controlling the operation of the controllable electronic component across the electrical interface between the other module and the secondary module.

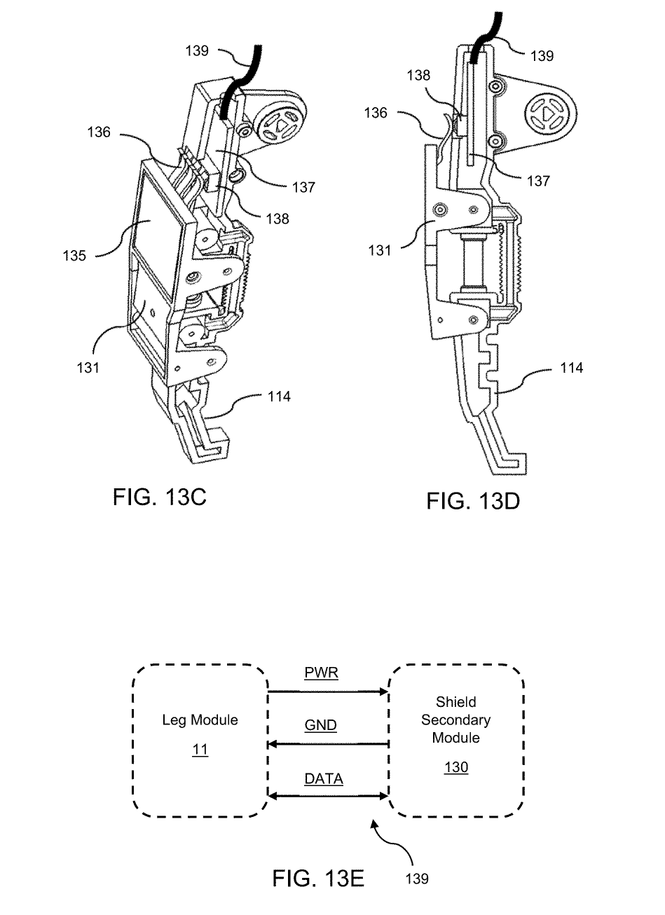

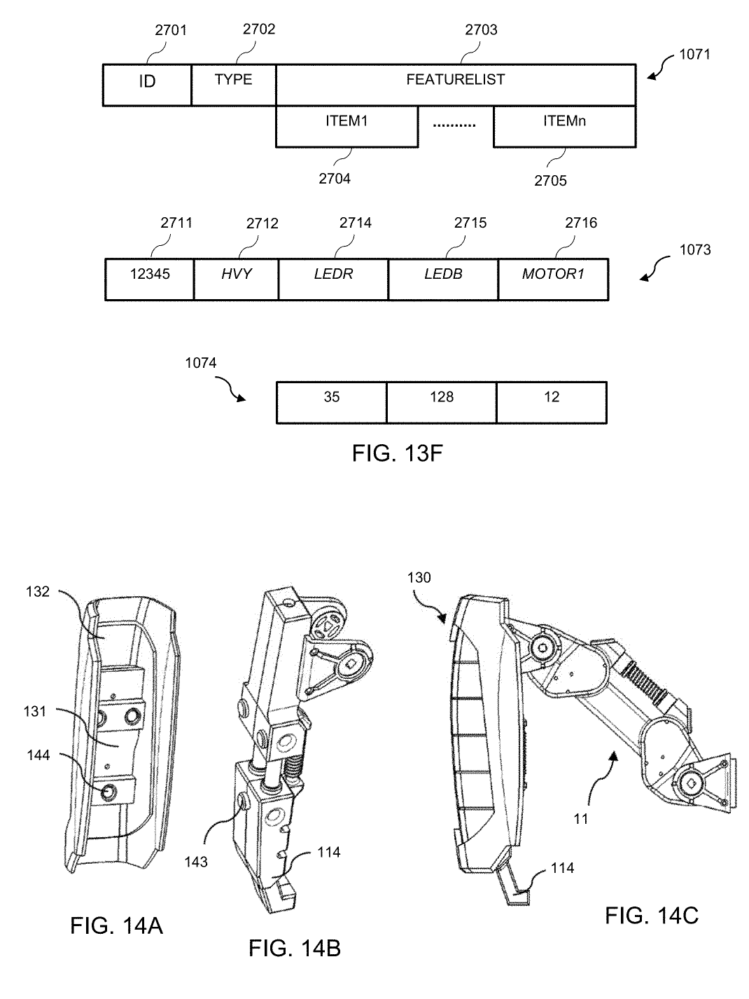

FIGS. 13A-13B and 13C-13D depict leg module 11 together with an example removable secondary module that can be attached to the leg module. In the illustrated example, the secondary module is a shield module in the form of a removable shield assembly 130 that can be clipped on or off lower leg 114 of the leg module 11. That is, the leg module 11 comprises at least one first coupling which is connectable to a second coupling on the shield secondary module 130. The first and second couplings are connectable to create a mechanical interface between the leg module 11 and the shield secondary module 130 and an electrical interface between the leg module 11 and the shield secondary module 130. The shield assembly 130 comprises a shield 132 and a shield bracket 131 that may be fixed to shield 122, e.g. using screws. In other examples the shield bracket 131 may be formed integrally with the shield 132. The mechanical interface between the shield assembly 130 and the lower leg 114 is, in this particular example, achieved by means of four plastic spring tabs 134 built into (that is, formed integrally with) the shield bracket 131. The spring tabs 134 are designed to deflect upon engaging with four corresponding sockets 133 on the lower leg 114. In other examples, a shield secondary module may comprise a coupling of the same type as any of the couplings 75, 76, 95, 96, 105 and 106 described above, connectable to a corresponding coupling of the same type on another module of the robot. In such examples the mechanical and electrical interfaces created between the secondary module and the other module of the robot may have any of the features of the mechanical and electrical interfaces described above in relation to the robot 10. The particular mechanical connection features depicted are intended to be illustrative examples only, and any other suitable mechanical connection features could alternatively be used to create the mechanical interface between a secondary module and another module of the robot.

The shield assembly 130 depicted in FIGS. 13A-13B and 13C-13D is “active” (that is, it comprises electronic components) and electrically interfaces with the lower leg 114. Both the shield assembly 130 and the lower leg 114 house a printed circuit board (not depicted) and each of the four tabs 134 comprises an electric conductor, configured to plug into (that is, form an electrical interface with) the four sockets 133 of lower leg 114, which are also electrically conductive. In this particular example up to four individual electrical connections are possible between the shield assembly 130 and the lower leg 114. A given individual electrical connection may be used, for example, to supply power to the shield (e.g. to power light emitting diodes (LED) comprised in the shield), or for digital communication between the leg module 11 and the shield assembly 130 (e.g. during a process of identifying a type of the shield 132). The particular electrical connection features depicted are intended to be illustrative examples only, and any other suitable electrical connection features could alternatively be used to create the electrical interface between a secondary module and another module of the robot.

FIGS. 13C-13D only depict the shield bracket 131 and the shield 132 has been omitted for clarity. Similarly, only one half of the lower shell of the leg module 11 is depicted for clarity. It can therefore be seen that the shield assembly 130 incorporates a printed circuit board 135, whilst lower leg 114 incorporates a printed circuit board 127. The electrical connection between the shield printed circuit board 135 and the lower leg printed circuit board 137 is achieved using a set of electrically conductive spring tabs 136 on shield printed circuit board 135 and corresponding connectors 138 on lower leg printed circuit board 137. In this particular example, the four electrical connections formed by the tabs 136 and the connectors 138 when the shield assembly 130 is connected to the leg module 11 comprise three electrical connections for providing power to lights (not depicted) comprised in the shield, and a data connection for transmitting shield identification information from the shield assembly 130 to the leg module 11 (so that the shield identification information may be passed, for example, to the main module 12 of the robot).

FIG. 13E shows an example electrical interface 139 between a leg module 11 and a shield secondary module 130. This electrical interface 139 may be provided by tabs 136 and connectors 138 as shown in FIGS. 13C and 13D. At least three connections are provided: a first channel PWR carrying a power supply; a second channel GND for a ground signal; and a third channel DATA for data exchange. The connections 139 may be respectively electrically coupled (directly or indirectly) to the 6V, GND-P and DATA connections of a coupling connecting the leg module 11 to a further module of the robot 10 (e.g. the body module 13). The 6V and GND-P channels may be indirectly electrically coupled to a coupling connecting the leg module 11 to a further module via a regulator in the leg. Similarly, the DATA channel may be indirectly coupled to the coupling connecting the leg module 11 to the further module via a microcontroller in the leg module 11. Such connections to the further module allow the main processing module of the robot 10 to read or otherwise obtain data identifying the shield secondary module 130 from the electronic circuitry of said shield secondary module 130.

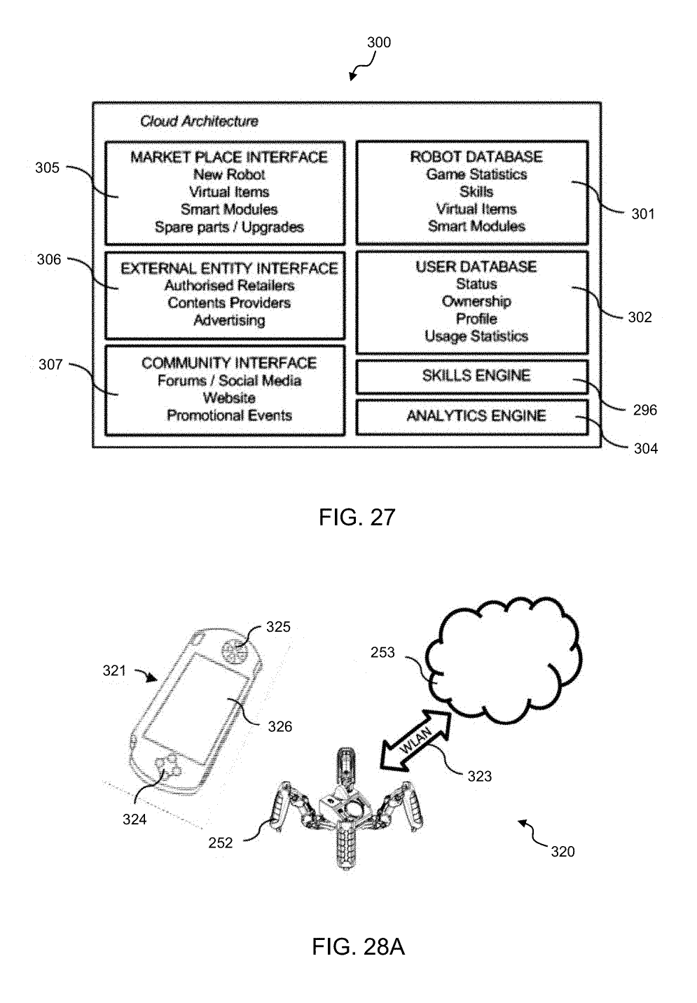

FIG. 13F shows a schematic illustration of an example data packet format 1071 and example data 1073, 1074 that may be transmitted from the electronic circuitry of a secondary module (first electronic circuitry) to the electronic circuitry of a primary module (second electronic circuitry), via an electrical interface between the secondary module and the primary module. The data packet format 1071 shown in FIG. 13F comprises an identifier (ID) 2701, a type string (TYPE) 2702 and a feature list (FEATURELIST) 2703. The feature list 2703 comprises a data structure having zero or more items; in FIG. 27 a first item (ITEM1) 2704 to an nth item (ITEMn) 2705 are shown, however the list need not have any items (in this case the list may be empty). Each of data 2701 to 2703 may be a fixed length (e.g. a fixed number of bits) or may be variable length data structure marked by start and stop bit sequences. The data packet format 1071 may be used to communicate data identifying the secondary module (which may be, e.g., a newly-connected secondary module). The identifier 2701 may be a globally unique identifier for the secondary module. The type string 2702 may be used by the main processing module to determine a module type so as to retrieve corresponding control routines to control said module. In certain cases the type string 2702 may be omitted, for example control information may be alternatively retrieved based on a look-up operation by main processing module using identifier 2701.

The example data 1073 conforms to the data packet format 1071. An identifier 2701 value of “12345” is set. The identifier may be a 16, 32 or 64-bit sequence, such as an integer. In other embodiments the identifier may comprise a 256, 512 or larger bit sequence representing an encrypted value or result of a cryptographic function. The type string 2702 is set as a string value of “HVY” 2712, e.g. indicating a “heavy” shield or weapon secondary module. The feature list of example data 1073 comprises three items: a string value “LEDR” 2714 indicating that the module comprises a red LED and that control values for this LED should be provided as a first data item; a string value “LEDB” 2715 indicating that the second module comprises a blue LED and that control values for this LED should be provided as a second data item; and a string value “MOTOR1” 2716 indicating that the second module comprises a motor and that control values for this motor should be provided as a third data item.

Example data 1073 may be read by the first electronic circuitry from a memory of the second electronic circuitry. Example data 1073 may be read by the first electronic circuitry in response to a request received by the first electronic circuitry from the main processing module (e.g. if the first electronic circuitry is comprised in a module other than the main module 12). The first electronic circuitry may transmit the data 1073 to the main processing module. The main processing module may transmits this data to a coupled computing device to set attributes of the gaming robot. If a computing device is not connected then the main processing module 210 may cache this data for later transmission. For example, a simulated mass of the gaming robot may be set based on the “HVY” type 2712 or based on a lookup using the identifier 2711 (e.g. the type may be implicit in the identifier).

Example data 274 may be sent to the secondary module from the main processing module 210 via the first electronic circuitry and the second electronic circuitry as a data packet to control the active electronic components set out in feature list 2703. Example data, in this case, comprises three 8-bit data values that are received serially by a microcontroller of the second module (the values being “35”, “128” and “12”). The value “35” controls a level of the red LED identified by item 2714; the value “128” controls a level of the blue LED identified by item 2715; and value “12” controls a position or speed of the motor identified by item 2716.

In some examples a mechanical interface between the shield assembly 130 and the lower leg 114 may be achieved by means of magnets. FIGS. 14A-14C illustrates one such example. In this particular example, the shield bracket 131 comprises three magnets 144. The magnets 144 are configured to guide the shield assembly 130 into a connection position, and then hold it in the connection position, upon engaging with three corresponding magnets or ferromagnetic pads 143 on the lower leg 114. In this embodiment, the magnets 144 are connected to a printed circuit board (not depicted) located on the shield assembly 130 and the magnets (or ferromagnetic pads) 143 are connected to a printed circuit board (not depicted) comprised in the lower leg 114. Magnets (or ferromagnetic pads) 143 and magnets 144 are electrically conductive (e.g. iron, cobalt, nickel, neodymium magnets) and therefore also act as electrical connectors between the lower leg 114 and the shield assembly 130. This embodiment therefore creates both an electrical and a mechanical interface between the leg module 11 and the shield assembly 130 when the shield assembly 130 is connected to the leg module 11.

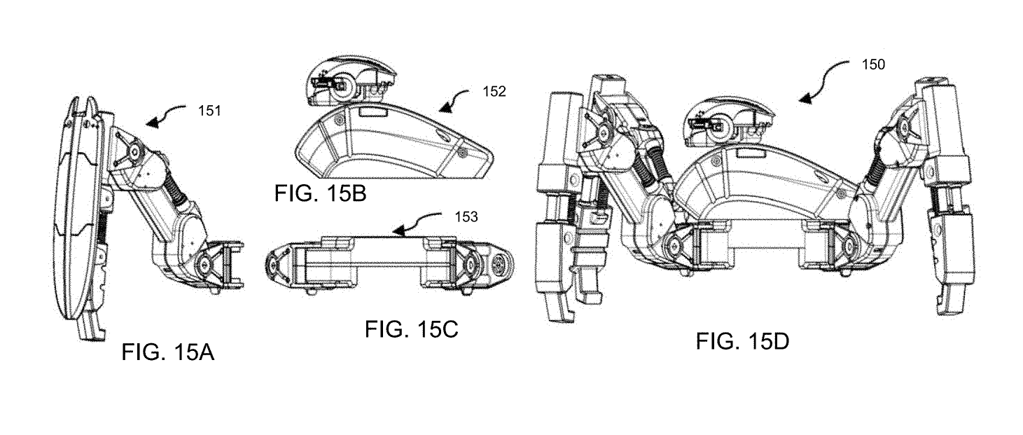

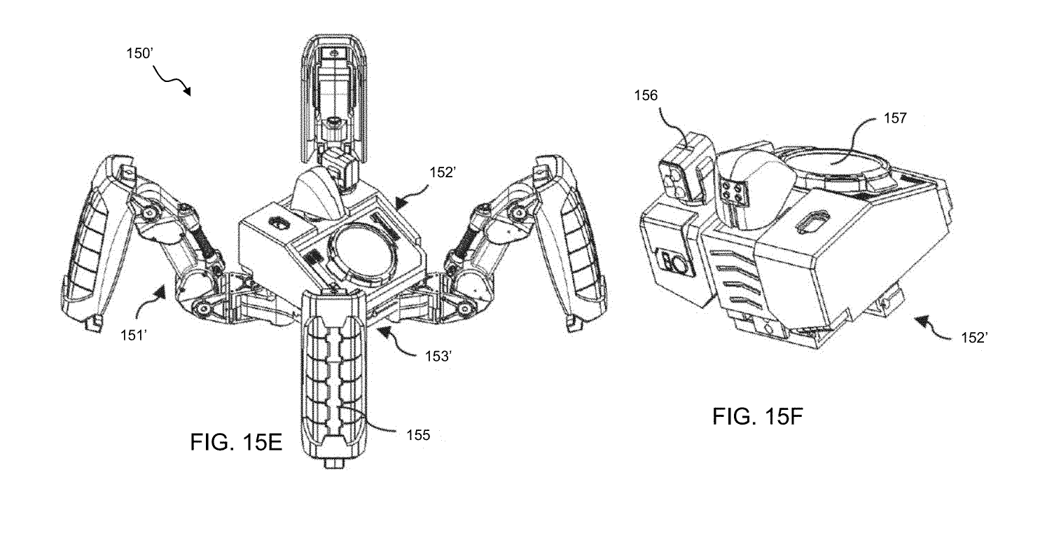

FIGS. 15A-15D and 15E-15F illustrate two different examples of modular robots according to the invention. FIGS. 15A-15D illustrate how three types of robot module (leg modules 151, a main module 152, and a body module 153 can be connected together to form a fully assembled modular robot 150 having a first configuration. Each module can be mechanically and electrically connected to and disconnected from the rest of the robot 10 with minimal skills or tools (for example in any of the manners described above in relation to FIGS. 7-12). Although the above description relates to the connection between a leg module 11 and the body module 13, in some examples the main module 12 that contains the “brain” of the robot 10 can also be easily connected to and disconnected from the body module 13, both mechanically and electrically.

FIGS. 15E-15F illustrate the removable nature of the main module in respect of a second modular robot 150′ having a second configuration. The robot 150′ comprises a main module 152′ that can be easily connected to (and disconnected from) a body module 153′ (which in this example is the same as the body module 153 of the robot 150) to form electrical and mechanical interfaces between the main module 152′ and the body module 153′ (for example in any of the manners described above in relation to FIGS. 7-12). Leg modules 151′ of the second modular robot 150′ are also connected to the body module 153′ using similar quick release connectors to those described above in relation to the robot 10.

FIGS. 15E-15F also illustrates how the easily interchangeable modules may be used to personalise a modular. The robot 150′ has a body module 153′ and leg modules 151′ that are of the same design as the corresponding body and leg modules 153, 151 of the robot 150. However; the main module 152′ (of the “Brute” design in this example) is different in appearance to the main module 152 of the robot 150. The second robot 150′ also has different shield assemblies 155 attached to its lower legs. The main module 152′ comprises, in this example, a removable weapon module 156 and a display screen 157 that may be used to display information about the robot and thereby enhance the game play experience.

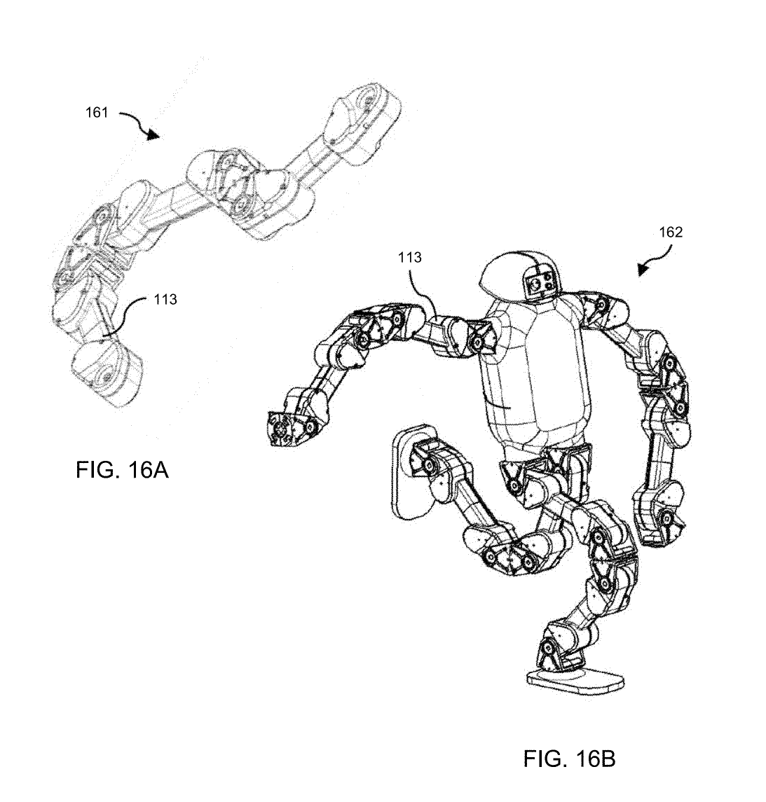

FIGS. 16 to 19 further illustrate how the modular nature of the examples described herein may be used customize a gaming robot. FIGS. 16A and 16B illustrate how thighs 113, which are normally used within leg locomotion modules of the same type as the leg module 11 described above, may be used to form a different type of locomotion module. The thighs 113 may be configured to be fully autonomous, such that they only require an external power supply to become fully functional. A plurality of thighs 113 can therefore be connected together to create a snake-like chain robot 161 (as shown in FIG. 16A) or a multi-jointed limb for a humanoid robot 162 (as shown in FIG. 16B). The connections between the thighs 113 in these examples may be effected by quick-release connectors, such as any of the connectors described above in relation to FIGS. 6-12.

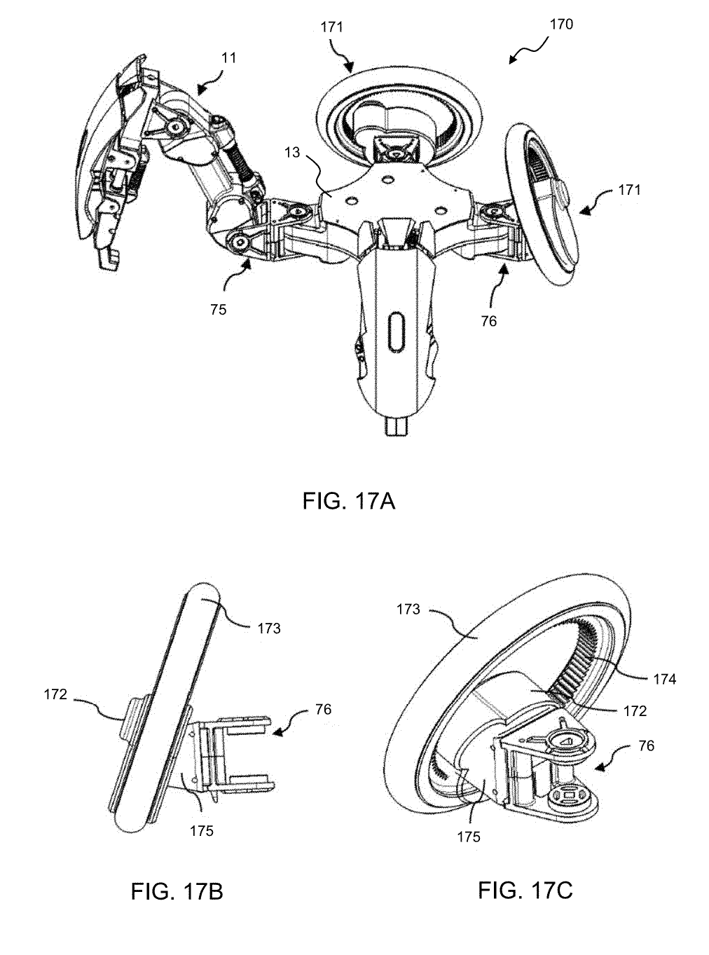

FIGS. 17A and 17B and 17C show an example wheeled robot 170. In this example the robot 170 comprises four locomotion modules, two of which comprise leg modules 11 (which in this example are the same as the leg modules of the robot 10 described above), and two of which comprise wheel modules 171. The wheel modules 171 (and the leg modules 11) mechanically and electrically interface with a robot body module 13 (which in this example is the same as the body module 13 of the robot 10 described above) using quick-release connectors, such as any of the connectors described above in relation to FIGS. 6-12. FIGS. 17B and 17C show in detail an example wheel module 171. The example wheel module 171 comprises a main gearbox and motor 172 and a hub-less wheel 173. The wheel 173 features an additional internal gear 174 and a coupling 175 compatible with the couplings 76 of the body module 13. The electrical connection between the wheel module 171 and the body module 13 is as described above in relation to FIG. 9.

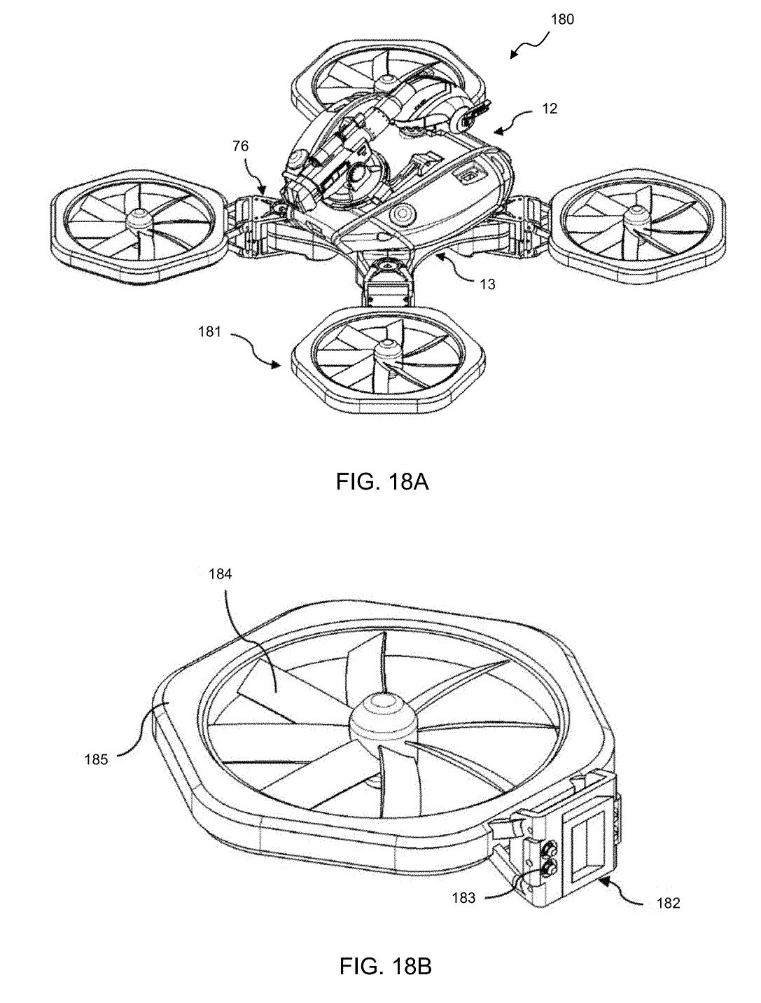

FIGS. 18A and 18B show an example flying robot 180 comprising four locomotion modules. In this example, all four locomotion modules comprise flying modules 181 that mechanically and electrically interface with a robot body module 13 (which in this example is the same as the body module 13 of the robot 10 described above) using quick-release connectors, such as any of the connectors described above in relation to FIGS. 6-12. The flying robot 180 also comprises a main module 12, which in this example is the same as the main module 12 of the robot 10 described above). FIG. 18B shows in detail an example flying module 181. The example flying module 181 comprises of a main casing 185 housing a motor and gearbox (not depicted), and a hub-less multi-bladed rotor 184. The example flying module 181 also comprises a coupling 182 compatible with the couplings 76 of the body module 13. The electrical connection 183 between the wheel module 181 and the body module 13 is as described above in relation to FIG. 9.

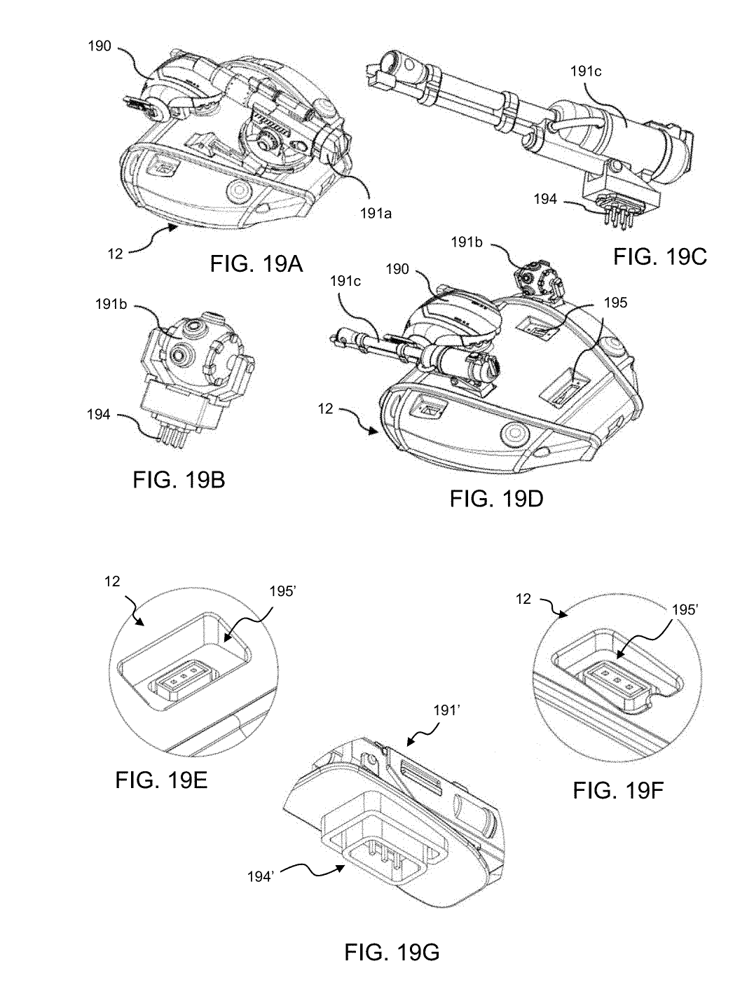

FIGS. 19A-G illustrate how a modular gaming robot (which in the illustrated example is the robot 10) can be further customized by connecting removable weapon secondary modules to the main module 12 of the robot 10. The weapon secondary modules may have any of the features of the shield secondary modules described above. Three different example types of weapon secondary module are shown in FIGS. 19A-19D. FIG. 19A shows a “Heavy Cannon” type weapon module 191a, FIG. 19B shows a “Shield Booster” type weapon module 191b, FIG. 19C shows a “Flamethrower” type weapon module 191c, and FIG. 19D shows a body module 12 having both a Shield Booster module 191b and a Flamethrower module 191c attached to it. Each of the secondary modules 191, 192, 193 comprises a coupling 194 configured to be plugged into a secondary module coupling 195 on the shell of the main module 12 shell. That is, the main module 12 comprises at least one first secondary module coupling which is connectable to a second secondary module coupling 194 on a secondary module 191a-c. The first and second secondary module couplings 195, 194, are connectable to create a mechanical interface between the main module and the secondary module and an electrical interface between the main module and the secondary module. In the illustrated example the mechanical interface is created by virtue of the first and second couplings being shaped to fit together in the manner of a plug and socket, and to have an interference fit when connected. The electrical interface, in the illustrated example, is created by a set of contacts (in the form of sockets) comprised in the first secondary coupling 195 being configured to make contact with a set of contacts (in the form of pins) comprised in the second secondary coupling 194 when the first and second secondary couplings are connected.

FIGS. 19E-19G show detail views of example first and second secondary module couplings 195′, 194′, which have an alternative configuration to the first and second secondary module couplings 195, 194 shown in FIGS. 19A-19D. That is, whereas the first and second secondary module couplings 195, 194 of FIGS. 19A-19D comprise six sockets and six pins respectively, the first and second secondary module couplings 195′, 194′ of FIGS. 19E-19G respectively comprise three sockets and three pins. Although FIGS. 19A-19D and 19E-19G show the first secondary module couplings 195, 195′ as comprising sockets and the second secondary module couplings 194, 194′ as comprising pins, in some examples this arrangement may be reversed such that some or all of the first secondary module couplings comprise pins and some or all of the second secondary module couplings comprise sockets.

In other examples, a weapon secondary module may comprise a coupling of the same type as any of the couplings 75, 76, 95, 96, 105 and 106 described above, connectable to a corresponding coupling of the same type on another module of the robot. In such examples the mechanical and electrical interfaces created between the weapon secondary module and another module of the robot may have any of the features of the mechanical and electrical interfaces described above in relation to the robot 10. In some examples, a weapon secondary module may comprise a coupling of any of the types described above in relation to the shield secondary modules.

Similarly to the shield assemblies 130 described above in relation to FIGS. 13 and 14, the weapon secondary modules 191, 192 and 193 are active. In the example depicted in FIG. 19 an electrical connection (interface) (e.g. for power supply and data communication) is achieved using pins comprised in the second secondary couplings 194, 194′, and the corresponding sockets comprised in the first secondary couplings 195, 195′. The secondary modules are interchangeable, such that any of the secondary modules 191a-c may be plugged into any of the second secondary couplings 195 of the main module 12. As with the shield secondary modules 130, the electrical connections between the main module 12 and the weapon secondary modules 191a-c can be used to power lights (LEDs) comprised in the weapon secondary modules 191a-c and/or to transmit weapon module identification information from a weapon secondary module 191a-c to the main module 12. FIGS. 19A-19D also show an example robot head module 190 connected to the main module 12 (e.g. using a connector of the same type used to connect the secondary modules 191, 192, 193 to the body module 12, or a quick-release connector as described above in relation to FIGS. 6-12). The head module 190 may be interchanged with another design of head module, or another type of module.

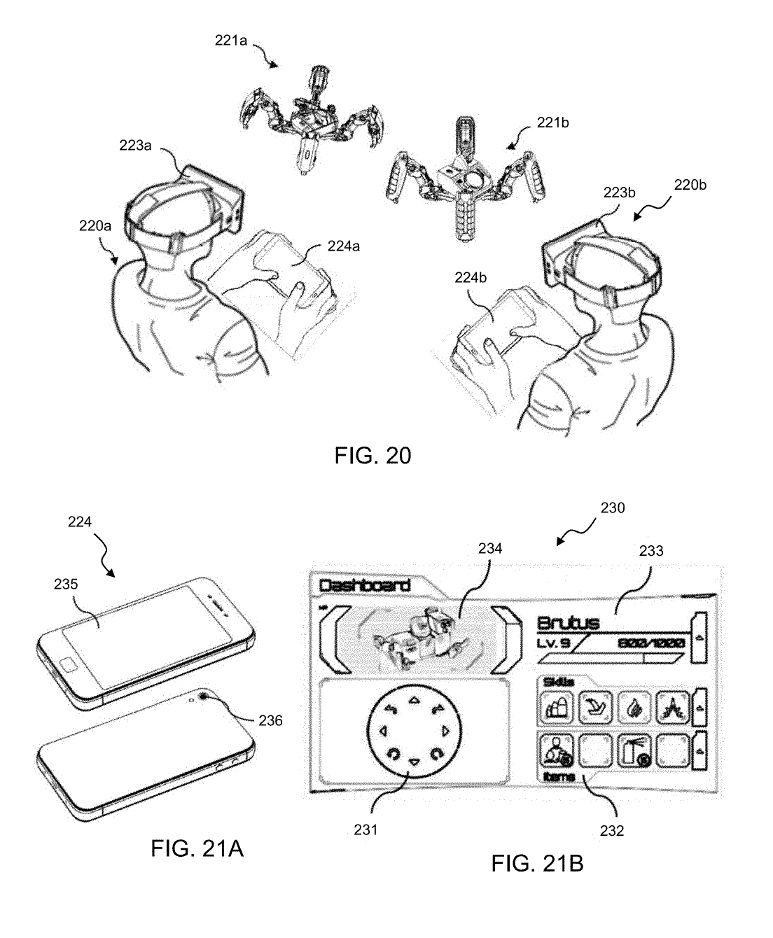

The examples disclosed herein relate in particular to gaming robots. The concept of a gaming robot will now be described in more detail with reference to FIGS. 20-22. FIG. 20 depicts two gaming robots 221a and 221b controlled by two users (players) 220a and 220b (that is, each gaming robot 221a, 221b is controlled by a different one of the two users 220a, 220b). However; it is possible for a single player to play with a single robot, or for any number of players to battle their robots 221 (in such situations, each player may have an associated gaming robot). Each gaming robot 221a, 221b is controlled using a connective device. A connective device may be, for example, a pair of augmented reality goggles 223, a mobile phone/computer tablet 224, or a combination of both. In the illustrated example, each player 220a, 220b is using a pair of augmented reality goggles 223a, 223b, and a mobile phone 224a, 224b. The connective devices 223a, 223b, 224a, 224b are able to transmit and receive information to and from the gaming robots 221a, 221b using wireless transmission (for example “WiFi” or “Bluetooth”). The connective devices 223a, 223b, 224a, 224b of each player 220a, 220b may also be interconnected to further enhance the player experience.

In certain embodiments involving use of augmented reality goggles, the processing capability of the goggles may be insufficient to achieve desired performance and may be supplemented with another device with adequate computing power (e.g., a desktop/laptop computer or a video game console).

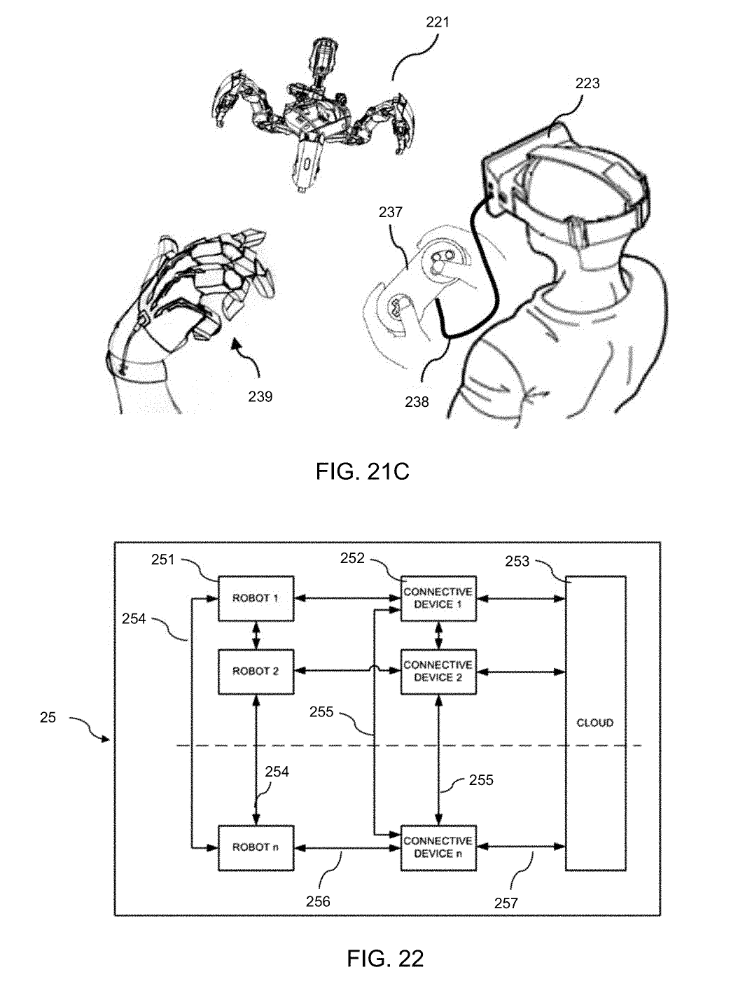

FIGS. 21A and 21B depict a mobile phone 224 that may be used as a connective device (remote computing device) to control a gaming robot. Mobile phone 224 features a tactile display screen 235 on its front and a video camera 236 on its back. The display 235 of mobile phone 224 displays a user interface 230 (shown in detail in FIG. 21B). The gaming robot 221 user interface 230 comprises, in this example, a first thumb operated (via the tactile screen 235) control pad 231 that is used to direct the gaming robot 221 in all directions (forward, backward, left, right, clockwise rotation, counter-clockwise rotation for example). The user interface 230 also comprises, in this example, a second thumb operated (via the tactile screen 235) control pad 232 that is used to select various skills and items that may be used during game play (weapons, healing power, opponent scanning, additional life for example).

The user interface 230 also comprises a “status” display 233 of the robot status as well as an “augmented reality” display 234. The “augmented reality” display 234 is used in conjunction with the video camera 236. Augmented reality display 234 broadcasts a real-time picture of the physical gaming robot 221 and its environment as captured within the field of view of camera 236, augmented with virtual reality features such as virtual opponents, a virtual environment/surroundings, and/or or virtual weapon effects.

FIG. 21C depicts a pair of augmented reality goggles 223 that may be used as a connective device to control a gaming robot. In the illustrated example the user interface 230 (which in this example is the same as the user interface 230 displayed by the mobile phone 224 of FIGS. 21A-21B) is displayed on the screen of goggles 223. The user 220 may still require an additional hand operated remote control to control the robot 221 device. Such a hand operated remote control may, for example, be similar to a controller normally used to play video games such as a gamepad 237 or a connected glove 239 designed to control the robot 221 by moving fingers in a predefined manner. In such examples, the gamepad 237 or glove 239 may be plugged into the goggles 223 with an electric cable 238, or alternatively may be wirelessly connected to the goggles 223 using wireless transmission (for example “WiFi” or “Bluetooth”).

In some examples (not illustrated) a mobile phone or tablet may be docked with a docking station comprising control buttons and/or one or more joysticks, to provide the user with a more ergonomic gamepad (i.e. similar to that of a video game controller) and/or in order to free-up space on the display of the mobile phone/tablet and thereby enhance gameplay.

FIG. 22 illustrates the top level architecture of an example gaming robot communication infrastructure 250 for a gaming robot 251. An unlimited number of robots 251 may be used at any moment in time. Each robot 251 is controlled by a player using a connective device 252 (e.g. smartphone, a computer tablet or a pair of augmented reality goggles). The robots 251 are able to communicate with each other via a wireless (e.g. WiFi or Bluetooth) data transmission 254. The connective devices 252 are also able to communicate with each other via a wireless (e.g. WiFi or Bluetooth) data transmission 255. It may also be possible for each connective device 252 to directly interrogate any robot 251 via a wireless (e.g. WiFi or Bluetooth) data connection (not depicted). In such examples any connective device 252 may be used to interrogate any robot 251 to access robot information (such as identification information and ownership information). However; at any given moment in time only one connective device 252 is able to control a given robot 251. Each connective device 252 may also be connected to a data server (e.g. the cloud) 253 via an active internet connection 257. The cloud 253 stores a number of gaming robot variables such as statistical data or player/robot profiles. The cloud 253 also acts as a market place where new skills, attributes or components may be purchased by the user via the connective device 252. If a robot 251 is within range of a wireless network connection, it may also be possible for the robot to directly communicate with the cloud 253.

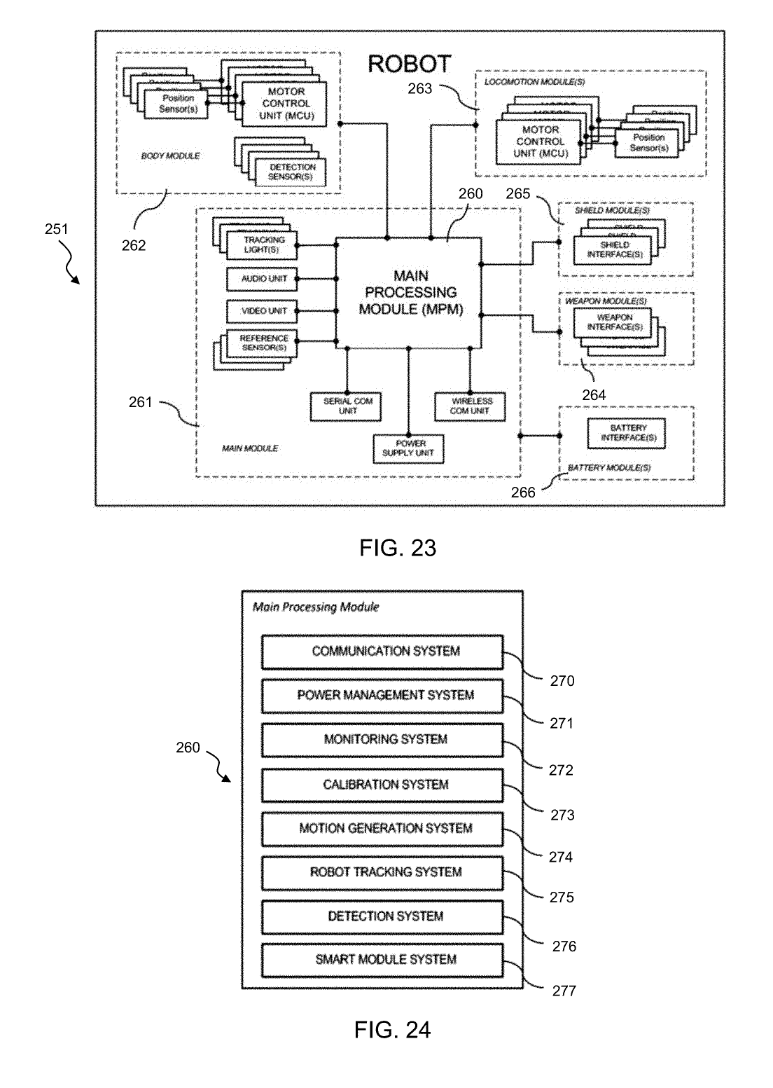

FIG. 23 depicts a detailed view of the system architecture of the robot 251. The architecture of the robot 251 essentially revolves around a main processing module (MPM) 260 housed within a main module 261 of the robot 251 (which may have any or all of the features of the main module 12 of the robot 10 described above). Within the main module 261, the main processing module 260 interfaces with tracking lights, audio and video devices, reference sensors, wired and wireless communication units and a power supply unit. As part of the main module 261 of robot 251, the main processing module 260 also interfaces with other modules of the robot 251. In particular, a body module 262, locomotion modules 263, secondary modules comprising shield modules 265 and weapon modules 264, and a battery module 266. The body module 262, locomotion modules 263 and secondary modules 265, 264 may have any or all of the features of the body module 13, locomotion modules 11, 171 and 181, and secondary modules 130, 191, 192, 193 described above.

FIG. 24 shows in more detail the systems found in the main processing module 260 and the functions these systems perform.

A Communication System 270 functions to handle all wired (e.g. USB during programming) and wireless (e.g. Bluetooth, WiFi during game play) communications between the robot 251 and its connected environment.

A Power Management System 271 functions to supply the robot 251 with primary and secondary supplies of power by regulating the battery module 266 voltage from a typical 12 Vdc supply down to 9 Vdc for the motors supply and 6 Vdc for other electronic components. Another function of the Power Management System 271 is to manage the charge and discharge of rechargeable batteries as required.

A Monitoring System 272 functions to provide a status of the health of the robot 251, including for example one or more of: power bus voltage, motors current draw, robot power consumption, battery discharge rate, the temperature of key components.

A Calibration System 273 is to calibrate sensors of the robot 251 during game play. Such sensors may include one or more of: a compass used as part of a tracking system, accelerometers, a gyroscope, GPS, an altimeter (e.g. for a flying robot). The Calibration System 273 may also include information about the prime movers, set in the factory during manufacture of the prime movers. Such information can enable compensation for manufacturing variations, e.g. in joints and gearboxes of the robot.

A Motion Generation System 274 functions to generate low level commands to the robot joints (e.g. prime movers outputs) in response to high-level commands received from a remote computing device 252 (e.g. a mobile phone or goggles) used to control the robot 251. This is achieved using a kinematics engine and position/speed feedback from motor controllers/position sensors of each of the prime movers. The kinematics engine may, for example, be configured to produce movement on the fly based on internal variables and input from remote devices. The Motion Generation System 274 may further comprise an animation system that replays stored routines. Such stored routines may be loaded onto the robot in the factory, or from the remote computing device.

A Robot Tracking System 275 functions to assist the remote computing device 252 in tracking the robot 251 in space during game play, in particular for the purpose of augmenting the reality of the game. This is achieved primarily by sequencing/controlling tracking lights comprised in the gaming robot 251 (typically provided on the main module 261 and/or on the locomotion modules 263) to compute a position and a direction of the gaming robot 251 or a part thereof. The tracking may be enhanced by the use of on-board sensors, when available, such as a compass, gyroscope or accelerometers.

A Detection System 276 functions to allow the robot 251 to detect opponents (e.g. other gaming robots) as well as its environment (e.g. obstacles) during game play. This is achieved by using detection sensors (e.g. infrared LED and receivers comprised in the robot 251, typically in the body module 262) to compute directions as well as an on-board camera comprised in the robot 251 (typically in a head module connected to the main module 261) to compute distances. The robot 251 may also comprise an audio unit (e.g. speaker and microphone) housed with main module 261, which may be used to detect an opponent by emitting and listening to specific sound patterns.

A Smart Module System 277 functions to detect the presence and identification of secondary modules (e.g. shield or weapon modules) attached to the robot and to relay the information to the remote computing device 252 used to control the robot 251 in order to update the attributes of the robot 251 within the game environment. In examples in which one or more of the secondary modules comprises lights (or other controllable electronic components), another function of the Smart Module System 277 is, to control the lights (or other controllable electronic components) of the one or more secondary modules, e.g. to add visual effects during game play.

Another function of the Smart Module System 277 is also to identify the type of a locomotion module 263 connected to robot 251 (e.g. legs, wheels or propellers) to inform the Motion Generation System 274 of the configuration of the robot (e.g. walking, rolling or flying). The Smart Module System 277 may also identify the type of a secondary module connected to the robot 251.

In some examples the Smart Module System may detect the presence of and identify any module which becomes connected to the robot 251. In such examples, the Smart Module System may therefore be considered to comprise an example of an identification system configured to detect the presence and identification of modules attached to a gaming robot.

An identification system for detecting the presence and identification of modules attached to a gaming robot according to the examples (e.g. the gaming robot 10 or the gaming robot 251) is configured to receive, from the gaming robot, data identifying a module connected to the gaming robot, and to determine, based on the received data, whether the module is authentic. The data identifying the module may have any of the features described above in relation to the modules of the robot 10. The receiving and determining functions may be performed (or may occur) in response to the identification system detecting that a module has been connected to the gaming robot. Such a detection may be triggered by the creation of an electrical interface between the module and the gaming robot. The identification system may be further configured to determine, based on the received data, a type of the module (that is, the module which has been newly connected to the gaming robot 251.

In some examples the received data is encrypted, and in such examples the identification system is further configured to decrypt the received data.

In some examples the identification system is configured to transmit a command to the gaming robot to disable operation of the gaming robot in response to a determination that the module is not authentic. The identification system may also communicate the determination (that is, the result of the determining) to a remote computing device for controlling the gaming robot. A remote computing device may be configured, for example, to refrain from sending commands to the robot for controlling the operation of a newly-attached module until the remote computing device has received a determination that the newly-attached module is authentic. Alternatively or additionally, a remote computing device may be configured to transmit a command to the gaming robot to disable operation of the gaming robot in response to a received determination that a newly-attached module is not authentic.

In a particular example, when a new module is attached to the robot 10 the following sequence may take place. First, the newly-attached module may be detected by the identification system based on a voltage on the SEN channel. Then the identification system may obtain the information identifying the newly-attached module. The identification system may then determine whether the newly-attached module is authentic based on the obtained identifying information (e.g. by cross-referencing the identifying information with a database stored in a memory accessible by the identification system). In some examples, the identifying information comprises a serial number and a version number, and determining whether the newly-attached module is authentic comprises checking the serial number and version number against a stored database. In some examples, in response to a determination that the newly-attached module is authentic, the identification system may pass the identifying information to the main processing module, which may then set any control variables in the electronic circuitry of the newly-attached module, e.g. based on a current configuration stored on the main processing module. If the newly-attached module is determined to be authentic and is a locomotion module, a current position of the newly-attached locomotion module may be measured, e.g. via the POT channel, and used to set position data in the main processing module. A current configuration of the gaming robot 10, including the identifiers of all attached modules, may then be stored by the main processing module and/or transmitted to a remote computing device (when such a remote computing device is communicatively coupled to the robot 10). In some examples the identifying information may comprise calibration data for the newly-connected module (particularly if the newly connected module comprises one or more prime movers and/or joints). The main processing module may use this data to compensate for any variations of the newly-attached module from the perfect.

In some examples, the newly-attached module may have a secondary module attached to it. In such examples, concurrently, or following the above-described sequence, the data identifying the secondary module may be obtained by the identification system and the authenticity of the secondary module may be determined based on the identifying data of the secondary module.

Although in the above described example the identification system is comprised in the Smart Module System 277 of the main processing module, in other examples an identification system which functions as described above may be comprised in a remote computing device (e.g. the mobile phone 224 or the remote computing device 252) for controlling a gaming robot according to the examples. If the identification system is comprised in a remote computing device, the information identifying the newly-attached module may be transmitted to the remote computing device via the main processing module of the gaming robot, and potentially (depending on the connection location of the newly-attached module) via one or more other modules. For example, if the newly-attached module is a shield module, connected to a coupling on a leg module, the identifying information may be transmitted from electronic circuitry in the shield module to electronic circuitry in the leg module, from the electronic circuitry in the leg module to electronic circuitry in a body module, from the electronic circuitry in the body module to a main processing module in a main module, and from the main processing module to the remote computing device.

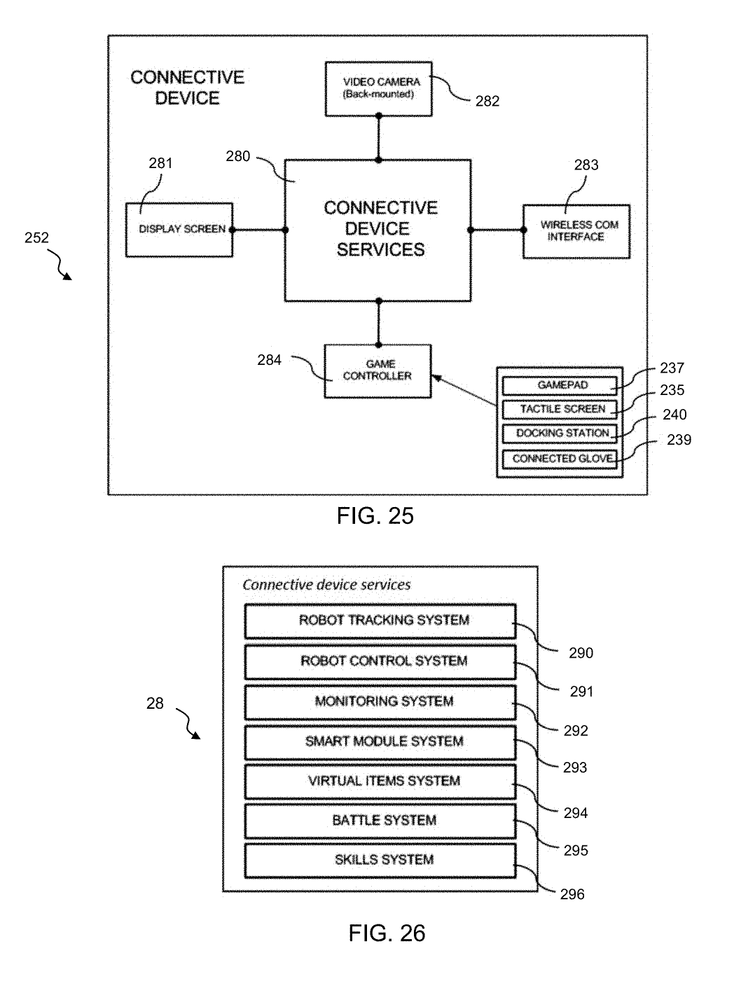

FIG. 25 depicts a detailed view of the system architecture of the connective device (remote computing device) 252. The architecture of the remote computing device 252 essentially revolves around a core processing unit (CPU) 280 of the remote computing device. The remote computing device 252 is equipped with a display screen 281 that acts as a user interface with robot 251. In the illustrated example a game controller 284 is also provided, to allow the user to control robot 251. A wireless communication interface 282 (e.g. WiFi or Bluetooth) is used to wirelessly control the robot 251. An optional video camera 282 may be provided if augmented reality is enabled. The game controller 284 may take any of several forms, depending on the type of remote computing device 252 used to control robot 251. For example, if the remote computing device comprises a mobile phone 224, the game controller may comprise a virtual (on screen) gamepad displayed on a thumb operated tactile screen 235 of the mobile phone 224.

As previously mentioned, to further enhance user experience, a docking station 240 may be used to dock a mobile phone 241 or a tablet 244, to provide the user with a physical gamepad. One of the benefits of such a docking station 240 is that it frees space on the display 235 of the phone 241 or tablet to enhance the gaming experience, in particular if augmented reality is implemented. If, instead of a phone or tablet, the remote computing device 252 comprises a pair of augmented reality goggles 223, then either a gamepad 237 or one or more connected gloves 239 may be used as a game controller 284.

FIG. 26 further details Connective Device Services 280 and the functions these services perform. The Robot Tracking System 290 functions to incorporate into the game the position, orientation, scale and attitude of the robot 251 based on the tracking data provided by robot 251, and to use this information to augment reality during gameplay on the display of connective device (remote computing device) 281. This may take the form of additional characters or obstacles as well as special effects such as flames, laser beam or explosions.

The Robot Control System 291 functions to send the high-level commands inputted by the user via game controller 284 to robot 251 wirelessly.

The Robot Monitoring System 292 functions to collect data on the health/status of robot 25 land update the robot status 233 on the user interface 230 with basic status information as shown in FIGS. 21A and 21B. More comprehensive health/status data is also uploaded to cloud 253 for storage and analysis.

The Smart Module System 293 functions to collect a status of the modules (e.g. weapons, shields, screen, type of locomotion module) attached to robot 251. The Smart Module System 293 provides inputs to the Battle System 295 that updates the gameplay accordingly by altering robot 251 attributes. In some examples the Smart Module System 293 of the remote computing device may comprise an identification system having the features described above in relation to the Smart Module System 277 of the main processing module.

The Virtual Items System 294 functions to collect a status of the virtual items owned by the user (e.g. cooling potion, healing potion, damage booster or speed booster). The Virtual Items System 294 provides inputs to the Battle System 295. Unlike physical smart modules (e.g. shields or weapons), virtual items are non-physical and cannot be “detected” by the robot. Instead virtual items are stored against a player/robot profile stored into cloud 253 and on connective device 252. Virtual items can be purchased online from market place 305 within cloud 253.

The Battle System 295 functions to compute the outcome of a battle based on data from other systems of robot 251. The outcome of a battle would for example be computed based on data from the Robot Tracking System 290, data from the Skills System 296 as well as data from the Smart Module system 293. For example upon detecting that a “Heavy” shield is installed, the Battle System 295 would make robot 251 more resilient to attacks and more tolerant to damages but the Battle System 295 would also slow robot 251 movements to reflect the bulk and weight of the “Heavy” shield.

The Skills System 296 functions to manage the skills that may become available to the player/robot over time. Skills (also known as perks) can be earned by the player/robot as he or she progresses (also known as levelling up) through the game. These skills can grant gameplay benefits to the player. For example, new skills may give the player/robot the ability to perform a new action, or giving a boost to one of the player/robot attributes. Skills are an input to the Battle System 295 and assist in computing the outcome of a battle.

FIG. 27 illustrates the architecture 300 of cloud 253 and its specific functions.

The function of the Robot Database 301 is to store data relating to each and every robot 251 and in particular data relating to the skills, smart modules, virtual items available and game statistics for each and every robot. The Robot Database 301 data is used as part of the game analytics and some of the data may be accessed by other users and members of the Community 307. An important aspect of the robot database is to collect the unique identifiers of each robot 251 and each robot module (e.g. main module, locomotion modules 263, body module 262, weapon secondary modules 264, shield secondary modules 265) to verify the legitimacy of each robots and protect against counterfeiting as well as assist with customer support, warranty claims or product recalls for example.

The function of the User Database 302 is to store data relating to each and every user 220, for example the status and profile of a user, usage statistics and robot ownership (if such user owns more than one robot). The User Database 302 data is used as part of the game analytics and some of the data may be accessed by other users and members of the community.

The function of the Skills Engine 303 is to pool all available skills (also known as perks) and manage the allocation/granting of skills to users/robots based on the data available from the Robot Database 301 and the User Database 302. Skills may be earned by the user as he or she progresses through the game.

The function of the Game Analytics Engine 304 is to utilise all the data collected for example via the Robot Database 301 and User Database 302 analyse and improve gameplay and user experience. An example of metrics used by the Game Analytics Engine 304 may be Playing time and frequency, preferred weapons, most effective shields, success rate, game progression, demographics. These metrics may be used to identify patterns and improve game play and user experience as a whole but may also be used to tailor the contents offered to each and every user by analysing individual data stored in databases 301 and 302.

The function of the External Entity Interface 306 is to allow the user access to licensed contents providers and for example purchase new games or access to authorised licensed retailers and purchase additional smart modules. The External Entity Interface 306 may also allow authorised advertisement during gameplay or be used to exchange/sell data with external partners.

The function of the Community 307 is to allow user/players to exchange information via forums or social media, share robots/users profiles, manage/organise events such as tournaments.

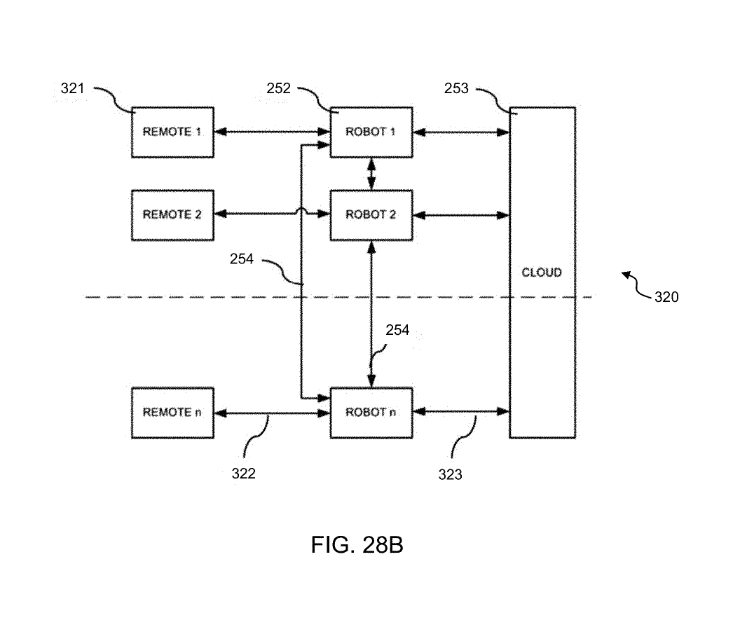

FIGS. 28A and 28B depict a simpler version of a gaming robot 320. In this example, a connective device (remote computing device) 320 consists of a dedicated remote controller with only limited functionalities and therefore reduced cost. In the illustrated example, the connective device 321 comprises an affordable non-tactile display 326 which features multiple control buttons 324 and one or more joysticks 325. The connective device 321 has minimal processing power and minimal connectivity, in order to limit cost. The wireless communication system of connective device 321 may rely on potentially cheaper infrared technology (e.g. IR) to control robot 252 instead of more expensive radiofrequency technology (e.g. WiFi or Bluetooth). In this particular example of a gaming robot 320, processing and wireless communication 323 with the cloud 253 is handled by directly by the robot 252. During multiplayer games, connective devices 321 may not be able to communicate with each other and instead interconnection between players/robots would be handled by the robots 252.

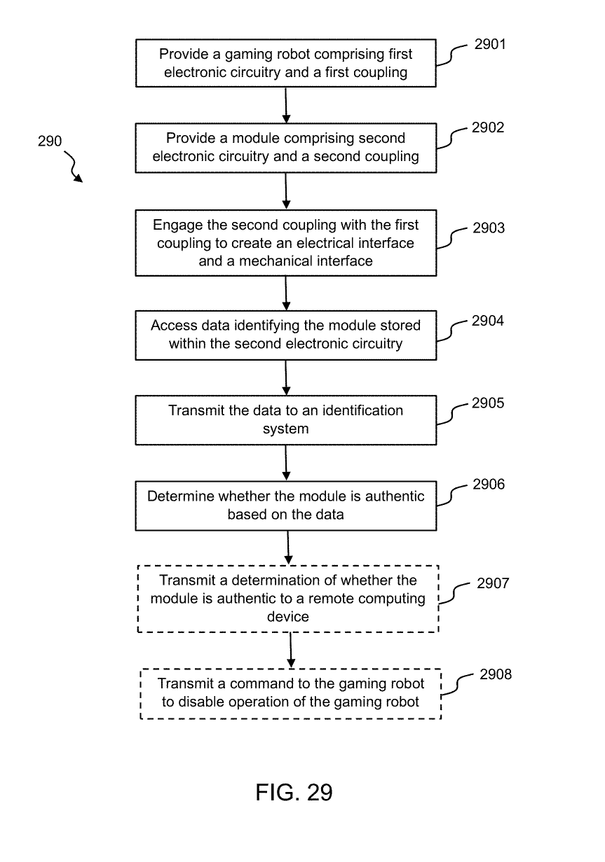

FIG. 29 is a flow chart illustrating an example method 290 of connecting a module to a gaming robot according to the examples (e.g. any of the gaming robots 10 or the gaming robot 252). It is envisaged that the processes represented by blocks 2904-2908 will be performed partially by the robot and partially by a remote computing device. However; examples are also possible in which all of the processes represented by blocks 2904-2908 are carried out by the robot.

In a first process block 2901, a gaming robot comprising at least one movable joint actuated by a prime mover is provided. The gaming robot comprises first electronic circuitry and a first coupling. The gaming robot may have any of the features of the example gaming robots 10, 252 described above.

In a second block 2902, a module to be connected to the gaming robot is provided. The module comprises second electronic circuitry and a second coupling. The module may be, for example, a locomotion module, a body module, a secondary module, etc. The module may have any of the features of any of the example modules described above in relation to the gaming robot 10 or the gaming robot 252.

In block 2903, the second coupling is engaged with the first coupling to create an electrical interface between the module and the gaming robot and a mechanical interface between the module and the gaming robot. The electrical interface and the mechanical interface may have any of the features described above in relation to the example gaming robot 10 or the example gaming robot 252. The engagement may be performed in any of the manners described above in relation to the example gaming robot 10 or the example gaming robot 252.

In block 2904 the first electronic circuitry accesses, via the electrical interface, data identifying the module stored within the second electronic circuitry. The data identifying the module may have any of the features described above in relation to the example gaming robot 10 or the example gaming robot 252, or example modules therefor. Accessing the identifying data may comprise, for example, electrical signals passing between the second electronic circuitry and the first electronic circuitry across the electrical interface. Accessing the identifying data may comprise the first electronic circuitry transmitting a read request to the second electronic circuitry.

In block 2905 the first electronic circuitry transmits the data (that is, the identifying data stored in the second electronic circuitry and accessed by the first electronic circuitry in block 2904) to an identification system configured to detect the presence and identification of modules attached to the gaming robot. The identification system may have any of the features of the example identification system described above. Transmitting the data may be performed in any of the manners described above in relation to the example gaming robot 10 or the example gaming robot 252. In some examples the identification system is comprised in a main processing module of the gaming robot, in which case transmitting the data comprises transmitting the data from the first electronic circuitry to the main processing module. In some such examples the first electronic circuitry may be comprised in the main processing module, in which case transmitting the data may comprise passing the data from a first function (e.g. a data receiving function) of the main processing module to a second function of the main processing module (e.g. an identification system function). In some examples the identification system is comprised in a remote computing device for remotely controlling the gaming robot, in which case transmitting the data comprises transmitting the data from the first electronic circuitry to the main processing module of the gaming robot, and then transmitting the data from the main processing module to the remote computing device.

In block 2906 the identification system determines whether the module is authentic based on the received data. Determining whether the module is authentic may be performed in any of the manners described above in relation to the example gaming robot 10 or the example gaming robot 252.

The illustrated method 290 also includes an additional optional block 2907, comprising transmitting a determination (that is, a determination generated as a result of performing block 2906) of whether the module is authentic to the remote computing device. The determination may be transmitted in any of the manners described above in relation to the example gaming robot 10 or the example gaming robot 252. This block may be performed, for example, if the identification system is comprised in the main processing module of the robot such that blocks 2904-2906 are all performed by the robot. However; it is generally expected that some of blocks 2904-2906 will be performed by the remote computing device.

The illustrated method 290 also includes an additional optional block 2908, comprising the identification system, in response to determining that the module is not authentic, transmitting a command to the gaming robot to disable operation of the gaming robot.

In some examples the command may be received from the remote computing device. In some examples the command may be transmitted in response to a request received from the remote computing device. In some examples, together with transmitting a command to the gaming robot to disable operation of the gaming robot, the identification system may transmit a notification to the remote computing device that the gaming robot has been disabled, and/or may cause a warning message to be displayed to a user, e.g. on a screen of the remote computing device. Transmitting a command to the gaming robot to disable operation of the gaming robot may be performed in any of the manners described above in relation to the example gaming robot 10 or the example gaming robot 252.

The above embodiments are to be understood as illustrative examples of the invention. Further embodiments of the invention are envisaged. For example, [add possibilities]. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A gaming robot comprising at least one movable joint actuated by a prime mover, the gaming robot comprising:
a first module comprising first electronic circuitry and a first coupling, the first coupling being connectable to a second coupling on a second module comprising second electronic circuitry to create a mechanical interface between the first module and the second module and an electrical interface between the first module and the second module;
wherein the first electronic circuitry is configured to:
in response to a connection of the second module to the first module, access via the electrical interface data stored within the second electronic circuitry, said data identifying the second module; and
transmit the data to an identification system configured to detect the presence and identification of modules attached to the gaming robot.

2. The gaming robot of claim 1, wherein the first module comprises a main module comprising a main processing module to control at least one other module of the gaming robot, and wherein the identification system is comprised in the main processing module.

3. The gaming robot of claim 1, wherein the gaming robot is controllable by a remote computing device and wherein the identification system is comprised in the remote computing device.

4. The gaming robot of to claim 1, wherein the first module comprises a main module comprising a main processing module to control at least one other module of the gaming robot, and the second module comprises one of: a locomotion module to provide robot motion; a shield module; a weapon module.

5. The gaming robot of claim 4, wherein the gaming robot is controllable by a remote computing device and wherein the main processing module is configured to control the at least one other module in response to commands received by the main processing module from the remote computing device.

6. The gaming robot of claim 4, wherein the second module comprises a controllable electronic component and wherein the first module is configured to transmit commands for controlling the operation of the controllable electronic component across the electrical interface.

7. The gaming robot of claim 6, wherein the second module comprises a locomotion module comprising a movable joint, the controllable electronic component comprises a prime mover to actuate the movable joint, and the commands comprise commands for controlling the prime mover to control movement of the second module.

8. The gaming robot of claim 1, wherein the first module comprises a locomotion module to provide robot motion and the second module comprises a secondary module.

9. The gaming robot of claim 8, wherein the first module comprises a main module and the locomotion module, connected such that an electrical interface and a mechanical interface exists between the main module and the locomotion module.

10. The gaming robot of claim 9, wherein the first electronic circuitry is comprised in the locomotion module and is configured to transmit the data to the identification system via further electronic circuitry comprised in the main module.

11. The gaming robot of claim 1, wherein the first coupling is connectable to the second coupling to create an electrical interface comprising a power supply interface for powering one or more active electronic components comprised in the second module, and a data communication interface for transmitting data between the first module and the second module.

12. The gaming robot of claim 1, wherein the first coupling comprises a surface shaped to create a first set of formations configured to engage with a second set of formations on the second coupling to resist movement of the first coupling relative to the second coupling.

13. The gaming robot of claim 12, wherein at least one of the first and second modules comprises a locomotion module having at least one pivoting joint, and wherein the first set of formations is configured to engage with the second set of formations on the second coupling to resist one or more of:
rotational movement of the first coupling relative to the second coupling about an axis parallel to the pivotal axis of the pivoting joint; and.
movement of the first coupling relative to the second coupling in a plane perpendicular to the pivotal axis of the pivoting joint.

14. The gaming robot of claim 12, wherein the first set of formations is configured to engage with the second set of formations on the second coupling to resist movement of the first coupling relative to the second coupling along all axes, and wherein at least one of the formations in the first set or the second set of formations is selectively releasable to permit relative movement of the first coupling relative to the second coupling along a selected axis.

15. A module for connection to a gaming robot comprising at least one movable joint actuated by a prime mover, the module comprising:
electronic circuitry storing data identifying the module; and
a first coupling connectable to a corresponding second coupling of the gaming robot to create a mechanical interface between the module and the gaming robot and an electrical interface between the module and the gaming robot, for enabling the gaming robot to access the stored data.

16. The module of claim 15, wherein the module comprises one or more active electronic components, and wherein the first coupling is connectable to the corresponding second coupling to create an electrical interface comprising a data communication interface to transmit commands for controlling the one or more active electronic components and a power supply interface for supplying power to the one or more active electronic components.

17. The module of claim 15, wherein the data identifying the module comprises a unique identifier associated with the module.

18. (canceled)

19. (canceled)

20. (canceled)

21. (canceled)

22. An identification system for detecting the presence and identification of modules attached to a gaming robot comprising at least one movable joint actuated by a prime mover, the identification system being configured to:
receive, from the gaming robot, data identifying a module connected to the gaming robot; and
determine, based on the received data, whether the module is authentic.

23. (canceled)

24. (canceled)

25. The identification system of claim 22, wherein the identification system is configured to transmit a command to the gaming robot to disable operation of the gaming robot in response to a determination that the module is not authentic.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. A connection system for a gaming robot controllable by a remote computing device, the gaming robot comprising a plurality of leg modules, each leg module comprising a plurality of prime movers to rotate portions of the leg module about a respective plurality of axes, a main module comprising a main processing module to control said plurality of leg modules; and a least one disconnectable module, the connection system comprising:
a first electronic circuitry and a first coupling, the first electronic circuitry and the first coupling being comprised in a primary part of the gaming robot which comprises at least the main module;
a second electronic circuitry and a second coupling configured to connect to the first coupling, the second electronic circuitry and the second coupling being comprised in the at least one disconnectable module; and
a third electronic circuitry, the third electronic circuitry being comprised in the remote computing device and being communicatively coupled to the first electronic circuitry;
wherein at least one of the first electronic circuitry and the third electronic circuitry comprises an identification system configured to detect the presence and identification of modules attached to the gaming robot;
wherein the first coupling and the second coupling are configured to create an electrical interface and a mechanical interface between the primary part and the module when the first coupling is connected to the second coupling;
wherein the second electronic circuitry stores a unique identifier identifying the at least one disconnectable module;
wherein the first electronic circuitry is configured to read the unique identifier in response to the second coupling becoming connected to the first coupling and transmit the unique identifier to the identification system; and
wherein the identification system is configured to determine whether the at least one disconnectable module is authentic based on the unique identifier.

39. A coupling pair for connecting two modules of a modular gaming robot, the coupling pair comprising:
a first coupling having a first set of electrical contacts and a first connection surface shaped to create a first set of formations; and
a second coupling having a second set of electrical contacts for cooperating with the first set of electrical contacts to create an electrical interface when the two modules are connected, and a second connection surface shaped to create a second set of formations;
wherein at least one of the two modules forms part of a pivoting joint of the modular robot; and
wherein the first set of formations and the second set of formations are configured such that movement of the first coupling into engagement with the second coupling along a connection axis substantially normal to the first connection surface creates a mechanical interface between the first coupling and the second coupling which resists further relative movement of the first coupling and the second coupling along the connection axis and which resists rotational movement of the first coupling relative to the second coupling around an axis parallel to the pivotal axis of the pivoting joint.

40. (canceled)

41. (canceled)

42. (canceled)

43. (canceled)

44. (canceled)

45. (canceled)

46. (canceled)

47. (canceled)

48. (canceled)

49. (canceled)
